(19) United States
(12) Patent Application Publication
(10) Pub. No.: US 2025/0254456 A1
(43) Pub. Date: Aug. 7, 2025

(54) ACOUSTIC DEVICES

(71) Applicant: SHENZHEN SHOKZ CO., LTD., Shenzhen (CN)

(72) Inventors: Jianing LIANG, Shenzhen (CN); Zhen WANG, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/186,612

(22) Filed: Apr. 22, 2025

Related U.S. Application Data
(63) Continuation of application No. PCT/CN2023/134372, filed on Nov. 27, 2023.

(30) Foreign Application Priority Data
Jun. 15, 2023 (WO) PCT/CN2023/100403

(51) Int. Cl. H04R 1/10; H04R 1/32

(52) U.S. Cl. CPC H04R 1/1016; H04R 1/1058; H04R 1/323

(57) ABSTRACT

An acoustic device is provided, including: a diaphragm; a housing configured to accommodate the diaphragm and form a first acoustic cavity and a second acoustic cavity corresponding to a front side and a rear side of the diaphragm. The diaphragm radiates sound into the first acoustic cavity and the second acoustic cavity, and the sound in the first acoustic cavity and the sound in the second acoustic cavity are guided out through a first acoustic hole coupled to the first acoustic cavity and a second acoustic hole coupled to the second acoustic cavity; a sound absorbing structure coupled to the second acoustic cavity and is configured to absorb the sound transmitted from the second acoustic cavity to the second acoustic hole in a target frequency range, the acoustic structure including a microperforated plate and a cavity, the microperforated plate including through holes.

### CROSS REFERENCE TO RELATED APPLICATIONS

This application is a Continuation of International Application No. PCT/CN 2023/134372, filed on Nov. 27, 2023, which claims priority to International Patent Application No. PCT/CN 2023/100403, filed on Jun. 15, 2023, the entire contents of each of which are incorporated herein by reference.

### TECHNICAL FIELD

The present disclosure relates to the field of acoustics, and in particular to an acoustic device.

### BACKGROUND

To solve the problem of sound leakage in a sound generation component, two or more sound sources are usually utilized to emit two acoustic signals with opposite phases. In the far field, a sound path difference between the sound sources with two opposite phases reaching a point in the far field is negligible, such that the two sound signals may cancel each other to reduce a sound leakage in the far field. Although this manner reduces the sound leakage to a certain extent, there are still some limitations. For example, due to a much shorter wavelength of a high frequency sound leakage, a distance between the two sound sources in the far field is non-negligible compared to the wavelength, resulting in the sound signals emitted by the two sources not being able to be canceled. As another example, when an acoustic transmission structure of the sound generation component resonates, the phase of the acoustic signal actually radiated by a sound outlet of the sound generation component has a certain phase difference from an original phase at a position where the sound wave is generated, and an additional resonance peak is added in the transmitted sound wave, which results in a chaotic sound field distribution, and makes it is difficult to ensure a sound leakage reduction effect in the far field at high frequencies, and even increases the sound leakage.

Therefore, it is desirable to provide an acoustic device with a better directional sound field.

### SUMMARY

One of the embodiments of the present disclosure discloses an acoustic device including: a diaphragm; a housing configured to accommodate the diaphragm and form a first acoustic cavity and a second acoustic cavity corresponding to a front side and a rear side of the diaphragm, respectively, the diaphragm radiating sound into the first acoustic cavity and the second acoustic cavity, respectively, and the sound in the first acoustic cavity and the sound in the second acoustic cavity are guided out through a first acoustic hole coupled to the first acoustic cavity and a second acoustic hole coupled to the second acoustic cavity, respectively; a sound absorbing structure coupled to the second acoustic cavity and is configured to absorb the sound transmitted from the second acoustic cavity to the second acoustic hole in a target frequency range. The acoustic structure includes a microperforated plate and a cavity, the microperforated plate including through holes, and the second acoustic cavity is in flow communication with the cavity through the through holes; and a suspension structure configured to place the housing at a position near an ear canal of a user without blocking an opening of the ear canal.

In some embodiments, a ratio of an open area of the first acoustic hole to an open area of the second acoustic hole is in a range of 0.5-2.

In some embodiments, a difference of acoustic loads between the first acoustic hole and the second acoustic hole is less than 0.15.

In some embodiments, an angle between a normal of a side of the microperforated plate facing the second acoustic cavity and a vibration direction of the diaphragm is in a range of 0°-90°

In some embodiments, the sound absorbing structure is disposed in the vibration direction of the diaphragm, and the angle between the normal of the side of the microperforated plate facing the second acoustic cavity and the vibration direction of the diaphragm is in a range of 0°-10° range.

In some embodiments, the acoustic device further includes a magnetic circuit assembly; and a coil connected to the diaphragm and at least partially disposed in a magnetic gap formed by the magnetic circuit assembly. After being powered, the coil drives the diaphragm to vibrate to produce sound, and the microperforated plate includes a ring structure disposed around the magnetic circuit assembly.

In some embodiments, a hole diameter of each through hole in the through holes is in a range of 0.2 mm-0.4 mm, a perforation rate of the microperforated plate is in a range of 1%-5%, a thickness of the microperforated plate is in a range of 0.2 mm-0.7 mm, and a height of the cavity is in a range of 4 mm-9 mm.

In some embodiments, the target frequency range includes 4 KHz.

In some embodiments, a hole diameter of each through hole in the through holes is in a range of 0.1 mm-0.3 mm, a perforation rate of the microperforated plate is in a range of 0.5%-5%, a thickness of the microperforated plate is in a range of 0.2 mm-0.6 mm, and a height of the cavity is in a range of 4 mm-10 mm.

In some embodiments, the target frequency range includes 2 kHz-3 kHz.

In some embodiments, the acoustic device further includes a magnetic circuit assembly; and a coil connected to the diaphragm and at least partially disposed in a magnetic gap formed by the magnetic circuit assembly. After being powered, the coil drives the diaphragm to vibrate to produce sound, and the microperforated plate and the magnetic circuit assembly are spaced apart in the vibration direction of the diaphragm.

In some embodiments, a hole diameter of each through hole in the through holes is in a range of 0.1 mm-0.2 mm, a perforation rate of the microperforated plate is in a range of 2%-5%, a thickness of the microperforated plate is in a range of 0.2 mm-0.7 mm, and a height of the cavity is in a range of 7 mm-10 mm.

In some embodiments, the target frequency range includes 4 kHz.

In some embodiments, a hole diameter of each through hole in the through holes is in a range of 0.1 mm-0.3 mm, a perforation rate of the microperforated plate is in a range of 0.5%-5%, a thickness of the microperforated plate is in a range of 0.2 mm-0.6 mm, and a height of the cavity is in a range of 4 mm-10 mm.

In some embodiments, the target frequency range includes 2 kHz-3 kHz.

In some embodiments, the housing has a long axis direction and a short axis direction that are perpendicular to the vibration direction of the diaphragm and orthogonal to each other, the sound absorbing structure is disposed on a side of the diaphragm along the long axis direction, and an angle between the side of the microperforated plate facing the second acoustic cavity and the long axis direction is in a range of 0°-90°.

In some embodiments, the side of the microperforated plate facing the second acoustic cavity is perpendicular to the long axis direction.

In some embodiments, the housing has a long axis direction and a short axis direction that are perpendicular to the vibration direction of the diaphragm and orthogonal to each other, the acoustic sound absorbing structure is disposed on a side of the diaphragm along the short axis direction, and an angle between the side of the microperforated plate facing the second acoustic cavity and the short axis direction is in a range of 0°-90°.

In some embodiments, the side of the microperforated plate facing the second acoustic cavity is perpendicular to the short axis direction.

In some embodiments, the sound absorbing structure includes a plurality of independently disposed sub-sound absorbing structures, each sub-sound absorbing structure including a sub-microperforated plate and a sub-cavity.

### BRIEF DESCRIPTION OF THE DRAWINGS

The present disclosure is further illustrated in terms of exemplary embodiments. These exemplary embodiments are described in detail with reference to the drawings. These embodiments are not limiting, and in these embodiments, the same numbering denotes the same structure, wherein:

FIG. 1 is a schematic diagram illustrating an exemplary ear according to some embodiments of the present disclosure;

FIG. 2 is a structural diagram illustrating an exemplary acoustic device according to some embodiments of the present disclosure;

FIG. 3A is a schematic diagram illustrating an exemplary acoustic device in a wearing state according to some embodiments of the present disclosure;

FIG. 3B is a schematic diagram illustrating a structure of an acoustic device in a non-wearing state according to some embodiments of the present disclosure;

FIG. 4 is a schematic diagram illustrating an acoustic cavity formed by the acoustic device shown in FIG. 3A;

FIG. 5 is a schematic diagram illustrating an exemplary acoustic device in a wearing state according to some other embodiments of the present disclosure;

FIG. 6 is a schematic diagram illustrating an acoustic cavity formed by the acoustic device shown in FIG. 5;

FIG. 7 is a schematic diagram illustrating an acoustic device according to some embodiments of the present disclosure;

FIG. 8A is a schematic diagram illustrating a sound field distribution of the acoustic device shown in FIG. 7 at low and medium frequencies;

FIG. 8B is a schematic diagram illustrating a sound pressure level sound field distribution of the acoustic device shown in FIG. 7 at a high frequency;

FIG. 9 is a schematic diagram illustrating a structure of an acoustic device disposed with an sound absorbing structure according to some embodiments of the present disclosure;

FIG. 10 is a schematic diagram illustrating sound absorbing effects of acoustic devices using a metal microperforated plate and a non-metal microperforated plate, respectively according to some embodiments of the present disclosure;

FIG. 11 is a graph illustrating frequency response curves of acoustic devices using metal and non-metal microperforated plates, respectively according to some embodiments of the present disclosure;

FIG. 12 is a graph illustrating frequency response curves at a second acoustic hole measured with and without a 025HY-type gauze on a side of a microperforated plate facing a diaphragm according to some embodiments of the present disclosure;

FIG. 13 is a graph illustrating sound absorbing coefficients of sound absorbing structure of microperforated plates with different heights of cavities according to some embodiments of the present disclosure;

FIG. 14 is a graph illustrating a maximum sound absorbing coefficient and a 0.5 sound absorbing octave of different heights of cavities according to some embodiments of the present disclosure;

FIG. 15 is a schematic diagram illustrating sound absorbing effects of microperforated plates with hole diameters of 0.15 mm and 0.3 mm respectively according to some embodiments of the present disclosure;

FIG. 16 is a graph illustrating frequency response curves of microperforated plates 351 with hole diameters of 0.15 mm and 0.3 mm according to some embodiments of the present disclosure;

FIG. 17 is a schematic diagram illustrating a structure of an acoustic device with a sound absorbing structure according to some embodiments of the present disclosure;

FIG. 18 is a graph illustrating frequency response curves of a second acoustic cavity of an acoustic device corresponding to different filling rates of fill materials according to some embodiments of the present disclosure;

FIG. 19 is a schematic diagram illustrating a structure of an acoustic device disposed with a sound absorbing structure according to some embodiments of the present disclosure;

FIG. 20 is a schematic diagram illustrating a structure of another acoustic device disposed with a sound absorbing structure according to some embodiments of the present disclosure;

FIG. 21 is a schematic diagram illustrating an internal structure of an acoustic device according to some embodiments of the present disclosure;

FIG. 22 is a schematic diagram illustrating an internal structure of an acoustic device according to some embodiments of the present disclosure;

FIG. 23A is a graph illustrating frequency response curves at a second acoustic hole of the acoustic device;

FIG. 23B is a graph illustrating frequency response curves at another second acoustic hole of an acoustic device;

FIG. 24 is a schematic diagram illustrating an internal structure of an acoustic device according to some embodiments of the present disclosure;

FIG. 25A is a schematic diagram illustrating an internal structure of an acoustic device according to some embodiments of the present disclosure;

FIG. 25B is a schematic diagram illustrating an internal structure of another acoustic device according to some embodiments of the present disclosure;

FIG. 26 is a graph illustrating frequency response curves at a second acoustic hole of an acoustic device shown in FIGS. 25A and 25B;

FIG. 27 is a schematic diagram illustrating a structure of an acoustic device according to some embodiments of the present disclosure;

FIGS. 28A-28C are schematic diagrams illustrating structures of acoustic devices according to some embodiments of the present disclosure; Attorney Docket No. 20608-0369US00

FIGS. 29A-29C are schematic diagrams illustrating structures of acoustic devices according to some embodiments of the present disclosure; and

FIG. 30 is a schematic diagram illustrating a structure of an acoustic device according to some other embodiments of the present disclosure.

### DETAILED DESCRIPTION

To more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for those skilled in the art to apply the present disclosure to other similar scenarios based on the accompanying drawings without creative labor. Unless obviously obtained from the context or the context illustrates otherwise, the same numeral in the drawings refers to the same structure or operation.

It should be understood that the terms “system,” “device,” “unit,” and/or “module” as used herein is a method of distinguishing between different components, elements, parts, sections, or assemblies at different levels. However, the words may be replaced by other expressions if other words accomplish the same purpose.

As used in the disclosure and the appended claims, the singular forms “a,” “an,” and “the” include plural referents unless the content clearly dictates otherwise. In general, the terms “including” and “comprising” suggest only the inclusion of clearly identified operations and elements, which do not constitute an exclusive list, and the method or device may also include other operations or elements.

Flowcharts are used in the present disclosure to illustrate operations performed by a system according to embodiments of the present disclosure. It should be appreciated that the preceding or following operations are not necessarily performed in an exact sequence. Instead, operations may be processed in reverse order or simultaneously. Also, it is possible to add other operations to these processes or remove an operation or operations from these processes.

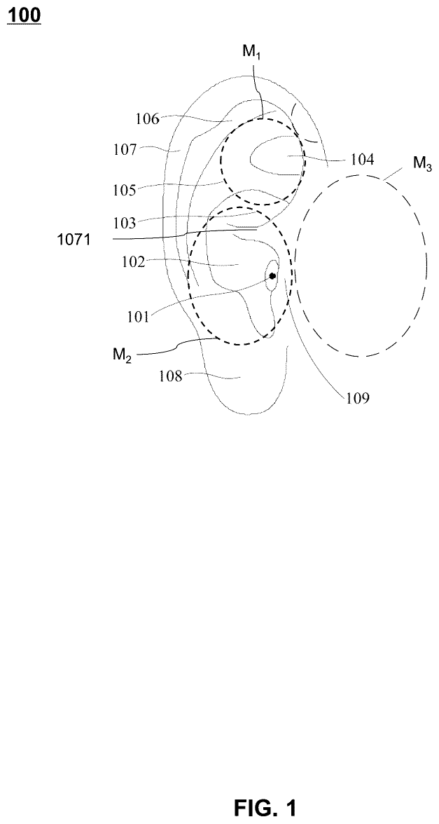

FIG. 1 is a schematic diagram illustrating an exemplary ear according to some embodiments of the present disclosure. Referring to FIG. 1, an ear 100 (which is also referred to as an auricle) may include an external ear canal 101, a concha cavity 102, a cymba conchae 103, a triangular fossa 104, an antihelix 105, a scaphoid 106, a helix 107, an earlobe 108, a tragus 109, and a crus of helix 1071. In some embodiments, one or more portions of the ear 100 supports the acoustic device to achieve a stable wearing of an acoustic device. In some embodiments, portions like the external ear canal 101, the concha cavity 102, the cymba conchae 103, the triangular fossa 104 have certain depths and volumes in a three dimensional space, which are used to realize a wearing requirement of the acoustic device. For example, the acoustic device (e.g., an in-ear earphone) is worn in the external ear canal 101. In some embodiments, a wearing of the acoustic device is realized with a help of other portions of the ear 100 other than the external ear canal 101. For example, the wearing of the acoustic device is achieved through the cymba conchae 103, the triangular fossa 104, the antihelix 105, the scaphoid 106, the helix 107, and other portions of the ear or a combination thereof. In some embodiments, an earlobe 108 and other portions of the ear of the user is further used to improve a comfort and a reliability of the acoustic device when the acoustic device is worn by the user. The wearing of the acoustic device and a sound transmission are implemented using portions of the ear 100 other than the external ear canal 101. In this way, the external ear canal 101 of the user may be “liberated.” When the user wears the acoustic device, the acoustic device does not block the external ear canal 101 (or the ear canal or an opening of the ear canal) of the user, and the user receives both a sound from the acoustic device and a sound from an environment (e.g., honking, car bells, sounds of people around, traffic commands, etc.), which reduce a probability of a traffic accident. In the present disclosure, the acoustic device that does not block the external ear canal 101 (or the ear canal or the opening of the ear canal) of the user when worn by the user may be referred to as an opening earphone. In some embodiments, the acoustic device is designed to fit the ear 100 according to a construction of the ear 100 to realize the wearing of a sound generation component of the acoustic device at various different positions on the ear. For example, when the acoustic device is an earphone, the earphone includes a suspension structure (e.g., an earhook) and a sound generation component. The sound generation component is physically connected to the suspension structure, and the suspension structure is adapted to a shape of the auricle to place a whole or a portion of a structure of the sound generation component on a front side of the tragus 109 (e.g., a region M3 surrounded by dashed lines in FIG. 1). As another example, the whole or the portion of the structure of the sound generation component is in contact with an upper portion of the external ear canal 101 (e.g., a position where one or more of the cymba conchae 103, the triangular fossa 104, the antihelix 105, the scaphoid 106, the helix 107, the crus of helix 1071, etc. are located) when the user is wearing the earphone. As a further example, when the earphones are worn by a user, the whole or a portion of the structure of the sound generation component may be located within a cavity formed by one or more parts (e.g., the concha cavity 102, the cymba conchae 103, the triangular fossa 104, etc.) of the ear 100 (e.g., a region M1 containing at least the cymba conchae 103, the triangular fossa 104 and a region M2 containing at least the concha cavity 102, as surrounded by the dashed lines of FIG. 1).

Individual differences may exist between different users in terms of different shapes, sizes, and other dimensional differences of the ears. For ease of description and understanding, if not otherwise specified, the present disclosure primarily use an ear model with a “standard” shape and size as a reference for further describing how the acoustic device in various embodiments is worn on the ear model. For example, a simulator with a head and its (left and right) ears, e.g. GRAS 45BC KEMAR is produced based on ANSI: S3.36, S3.25 and IEC: 60318-7, and taken as a reference for wearing the acoustic device to present a scenario in which a majority of the users would normally wear the acoustic device. For illustrative purposes only, the ears as the reference may have the following relevant features: a projection of the auricle on a sagittal plane in a vertical axis direction may have a size in a range of 49.5 mm-74.3 mm, the projection of the auricle on the sagittal plane in a sagittal axis direction may have a size in a range of 36.6 mm-55 mm. Accordingly, in the present disclosure, the words such as “worn by the user,” “in the wearing state,” and “under the wearing state” may refer to the acoustic device described in the present disclosure being worn on the ears of the aforementioned simulator. Of course, considering that there are individual differences among different users, a structure, a shape, a size, a thickness, etc. of one or more parts of the ear 100 may have certain differences, and to satisfy the needs of different users, the acoustic device may be differentiated, and these differentiated designs may be manifested in that feature parameters of one or more portions of the acoustic device (e.g., the sound generation component, the earhook, etc., in the following descriptions) have different ranges of values to accommodate different ears.

It should be noted that in fields of medicine and anatomy, three basic sections of the human body, namely, a sagittal plane, a coronal plane, and a horizontal plane, as well as three basic axes, a sagittal axis, a coronal axis and a vertical axis, are defined. The sagittal plane refers to a section perpendicular to the ground made along an front-rear direction of a body, which divides the body into left and right parts; the coronal plane refers to a section perpendicular to the ground made along a left-right directions of the body, which divides the body into front and back parts; and the horizontal plane refers to a section parallel to the ground made along an up-down direction perpendicular to the body, which divides the body into upper and lower parts. Correspondingly, the sagittal axis refers to an axis along the front-rear direction of the body and perpendicular to the coronal plane, the coronal axis refers to an axis along the left-right direction of the body and perpendicular to the sagittal plane, and the vertical axis refers to an axis along the upper-lower direction of the body and perpendicular to the horizontal plane. As another example, the “front of the ear” described in the present disclosure is a concept relative to the “rear of the ear,” where the “front of the ear” refers to a side of the ear that is away from the head, and the “rear of the ear refers to a side of the ear that is facing the head. By observing the ear portion of the above-described simulator along the coronal axis of the human body, a schematic diagram of the front side profile of the ear may be obtained as shown in FIG. 1.

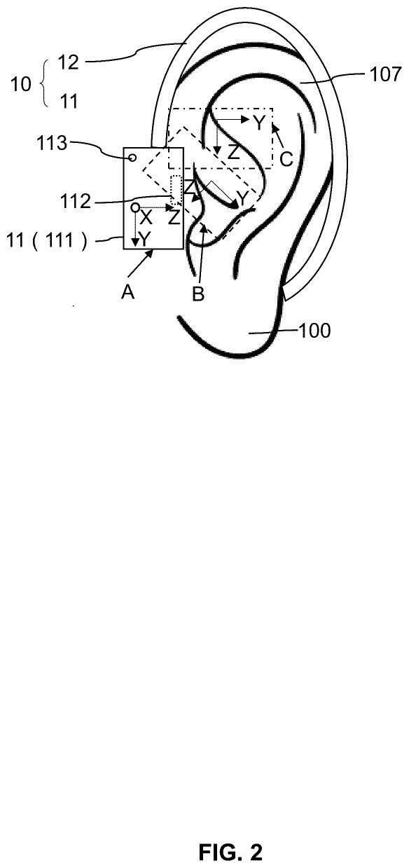

FIG. 2 is a structural diagram illustrating an exemplary acoustic device according to some embodiments of the present disclosure.

As shown in FIG. 2, the acoustic device 10 may include a sound generation component 11 and a suspension structure 12.

In some embodiments, the acoustic device 10 includes, but is not limited to, an air conduction acoustic device, a bone and air conduction acoustic device, etc. In some embodiments, the acoustic device 10 is combined with a product such as eyeglasses, a head-mounted acoustic device, a head-mounted display device, an augmented reality (AR)/visual reality (VR) helmet, etc. In some embodiments, the acoustic device 10 includes a low-frequency (e.g., 30 Hz-150 Hz) speaker, a low-mid-frequency (e.g., 150 Hz-500 Hz) speaker, a high-mid-frequency (e.g., 500 Hz-5 kHz) speaker, a high-frequency (e.g., 5 kHz-16 kHz) speaker or a full-range (e.g., 30 Hz-16 kHz) speaker, or any or any combination thereof. The low frequency, high frequency, etc., mentioned herein only indicate a general range of frequencies, and there may be different division manners in different application scenarios. For example, a frequency division point is determined, a low frequency indicates a frequency range below the frequency division point, and the high frequency indicates frequencies above the frequency division point. The frequency division point may be any value within an audible range of a human ear, e.g., 500 Hz, 600 Hz, 700 Hz, 800 Hz, 1000 Hz, etc.

As shown in FIG. 2, the acoustic device 10 may include a sound generation component 11 and a suspension structure 12.

In some embodiments, the acoustic device 10 is worn on a body of the user (e.g., a head, a neck, or an upper torso of the human body) by having the sound generation component 11 be worn via the suspension structure 12. In some embodiments, the acoustic device 10 is placed at a position near an ear canal without blocking an opening of the ear canal through the suspension structure 12.

In some embodiments, one end of the suspension structure 12 is connected to the sound generation component 11, and the other end of the suspension structure extends along a junction of the ear 100 and the head of the user. In some embodiments, the suspension structure 12 is an arc structure adapted to fit the ear 100 of the user, so that the suspension structure 12 is suspended on the ear 100 of the user. For example, the suspension structure 12 has an arc structure that adapts to the junction of the head and the auricle 100 of the user, so that the suspension structure 12 hangs between the auricle 100 and the head of the user. In some embodiments, the suspension structure 12 is a gripping structure adapted to the auricle 100 of the user so that the suspension structure 12 grips at the auricle 100 of the user. In some embodiments, the suspension structure 12 includes, but is not limited to, a suspended structure, an elastic band, etc., such that the acoustic device 10 is better fixed to the user and prevents the acoustic device 10 from dropping in use. In some embodiments, the acoustic device 10 does not include the suspension structure 12, and the sound generation component 11 is fixed to a vicinity of the auricle 100 of the user by means of suspension or clamping.

For example, when the acoustic device 10 is in a wearing state, the suspension structure 12 is hung between a rear side of the auricle 100 and the head of the user, with the sound generation component 11 in contact with a front side of the auricle 100 (e.g., a region M3 in FIG. 1) or the auricle 100 (e.g., a region M1 and a region M2 in FIG. 1) of the user, and the suspension structure 12, or the suspension structure 12 and the sound generation component 11 cooperates to provide a clamping force against the front side of the auricle 100 or against the auricle 100 for the sound generation component 11. The sound generation component 11 may be specifically pressed against the front side of the auricle 100 or a region where the concha cavity 102, the cymba conchae 103, the triangular fossa 104, the antihelix 105, etc. are located under an action of the clamping force, so as to enable the acoustic device 10 to be in the wearing state without blocking the opening of the ear canal 101 of the ear 100.

The sound generation component 11 may generate a sound to input into the ear canal of the user. In some embodiments, the sound generation component 11 has a regular shape such as circular, oval, runway shape, polygonal, U-shape, V-shape, semicircular, or other irregular shapes, so that the sound generation component 11 is directly affixed to the auricle 100 of the user. In some embodiments, the sound generation component 11 has a long axis direction Y, a short axis direction Z, and a thickness direction X that are orthogonal to each other. The long axis direction Y is defined as a direction with a greatest extension dimension in a shape of the two-dimensional projection plane (e.g., a projection of the sound generation component 11 on a plane where an inner side of the sound generation component 11 is located, or a projection of the sound generation component 11 on a sagittal plane) of the sound generation component 11 (e.g., the long axis direction is a length direction of a rectangle or near-rectangle when the projection shape is the rectangle or the near-rectangle). For simple illustration, the present disclosure is described in terms of a projection of the sound generation component on the sagittal plane. The short axis direction Z may be defined as a direction perpendicular to the long axis direction Y in the shape of the projection of the sound generation component 11 on the sagittal plane (e.g., when the shape of the projection is a rectangle or near-rectangle, the short axis direction is a direction of a width of the rectangle or near-rectangle). The thickness direction X may be defined as a direction perpendicular to the sagittal plane, e.g., in line with a direction of the coronal axis, both pointing to a left-right direction of the body.

In some embodiments, the sound generation component 11 includes a diaphragm (not shown in the figures) and a housing 111 for accommodating the diaphragm. The housing 111 (or the sound generation component 11) may be connected to the suspension structure 12. In some embodiments, the diaphragm is an element that receives an excitation signal and converts the excitation signal to a sound wave for output. In response to the excitation signal (e.g., an electrical signal), the diaphragm generates a corresponding mechanical vibration to produce sound. In some embodiments, the sound generation component 11 also includes a sound coil and a magnetic circuit assembly. One end of the sound coil is fixedly connected to the diaphragm, and the other end extends into a magnetic gap formed by the magnetic circuit assembly. By supplying an electric current to the sound coil, the sound coil vibrates in the magnetic gap, which in turn drives the diaphragm to vibrate to generate sound waves.

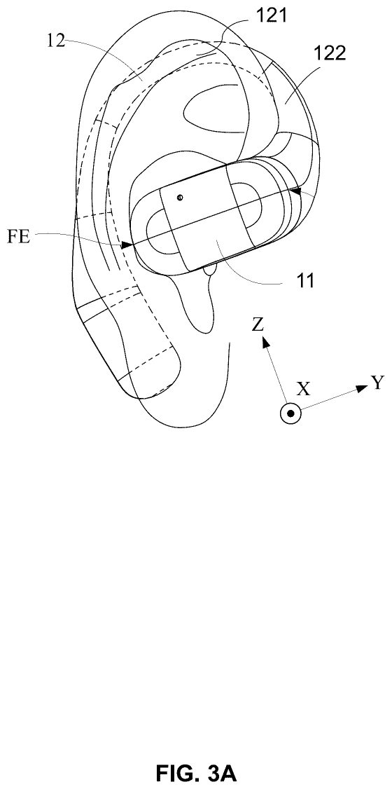

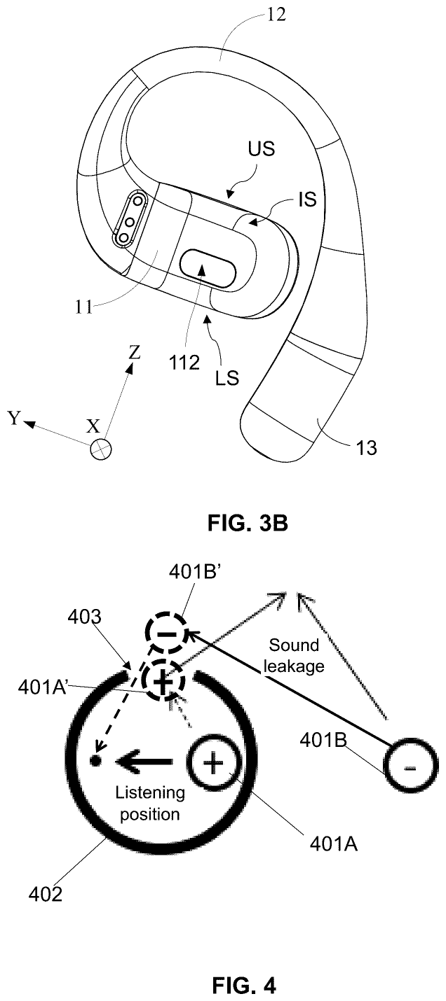

In some embodiments, the diaphragm separates the housing 111 into a first acoustic cavity and a second acoustic cavity of the acoustic device. A first acoustic hole 112 disposed on the housing 111 is acoustically coupled with the first acoustic cavity and exports a sound generated by the first acoustic cavity out of the housing 111. The second acoustic hole 113 disposed in the housing 111 is acoustically coupled with the second acoustic cavity and exports a sound generated by the second acoustic cavity out of the housing 111. In some embodiments, the first acoustic hole 112 is disposed on an inner surface of the housing 111 proximate to or facing the auricle 100, such that the first acoustic hole faces or proximate to the opening of the ear canal, which in turn allows the first acoustic hole 112 to transmit the sound generated by the diaphragm out of the housing 111 to the ear canal so that the user is able to hear the sound. The sound exported through the first acoustic hole 112 may also propagate to an exterior of the acoustic device 10 and the ear canal 100, thereby generating a first sound leakage of the sound in a far field. In some embodiments, the second acoustic hole 113 is disposed on other sides of the housing 111 (e.g., a side away from or depart from the ear canal of the user). The second acoustic hole 113 is farther away from the opening of the ear canal compared to the first acoustic hole 112, and the sound propagated out of the second acoustic hole 113 forms a second sound leakage in the far field. An intensity of the first sound leakage is comparable to an intensity of the second sound leakage, and the phases of the first sound leakage and the second sound leakage are opposite or approximately opposite to each other, which enables the first sound leakage and the second sound leakage to be canceled in the far field, which is conducive to reducing the sound leakage of the acoustic device 10 in the far field. More descriptions about the sound generation component 11 may be found elsewhere in the present disclosure, for example, in FIG. 3A and FIG. 3B and their corresponding contents.

In some embodiments, when the user wears the acoustic device 10, the sound generation component 11 is worn in a position near the ear canal of the user without blocking the opening of ear canal 101. In some embodiments, a projection of the acoustic device 10 on the sagittal plane does not cover the opening of the ear canal 101 of the user in the wearing state. For example, the projection of the sound generation component 11 on the sagittal plane falls on the left and right sides of the head and at a position front to the tragus in the sagittal axis of the human body (e.g., the position shown by the solid line box A in FIG. 2). At this time, the sound generation component 11 is located on the front side of the tragus of the user, the long axis of the acoustic portion 11 may be in a vertical or approximately vertical state, a projection of the short axis direction Z on the sagittal plane is consistent with the direction of the sagittal axis, a projection of the long axis direction Y on the sagittal plane is consistent with the direction of the vertical axis, and the thickness direction X is perpendicular to the sagittal plane. As another example, the projection of the sound generation component 11 on the sagittal plane falls on the antihelix 105 (e.g., at the position shown by the dashed box C in FIG. 2). At this time, the sound generation component 11 is at least partially disposed at the antihelix 105, the long axis of the sound generation component 11 is in a horizontal or approximately horizontal state, the projection of the long axis direction Y of the sound generation component 11 on the sagittal plane is consistent with the sagittal axis, the projection of the short axis direction Z on the sagittal plane is consistent with the direction of the vertical axis, and the thickness direction X is perpendicular to the sagittal plane. In this way, the sound generation component 11 is prevented from blocking the ear canal, thereby freeing the ears of the user; and a contact area between the sound generation component 11 and the ear 100 may be increased, thereby improving a wearing comfort of the acoustic device 10. In some embodiments, the projection of the acoustic device 10 on the sagittal plane also covers, or at least partially covers, the opening of ear canal 101 of the user in the wearing state, e.g., the projection of the sound generation component 11 on the sagittal plane falls within the concha cavity 102 (e.g., at the position shown by dashed box B of FIG. 2), and is contact with the crus of helix 1071 and/or the helix 107. In such cases, the sound generation component 11 is at least partially disposed in the concha cavity 102, and the sound generation component 11 is in an inclined state. The projection of the short axis direction Z of the sound generation component 11 on the sagittal plane is set at an angle with the direction of the sagittal axis, i.e. the short axis direction Z is also correspondingly inclined, the projection of the long axis direction Y on the sagittal plane has a certain angle with the direction of the sagittal axis, i.e. the long axis direction Y is also inclined, and the thickness direction X is perpendicular to the sagittal plane.

For example, in conjunction with FIG. 3A, an end FE of the sound generation component 11 extends into the concha cavity in the wearing state. Optionally, the sound generation component 11 and the suspension structure 12 are disposed to co-clamp the ear 100 from the front and rear sides of a region of the ear 100 corresponding to the concha cavity 102, so as to increase a resistance of the acoustic device 10 from falling off the ear, thereby improving a stability of the acoustic device 10 in the wearing state. For example, the end FE of the sound generation component is pressed in the thickness direction X within the concha cavity. As another example, the end FE abuts against the concha cavity in the long axis direction Y and/or the short axis direction Z (e.g., against an inner wall of the concha cavity opposite to the end FE). It should be noted that the end FE of the sound generation component 11 refers to an end of the sound generation component 11 that is opposite to a fixed end connected to the suspension structure 12, which is also referred to as a free end. The sound generation component 11 may be a regular or irregular structural body, and an exemplary illustration is disposed herein for further illustration on the end FE of the sound generation component 11. For example, when the sound generation component 11 is a rectangular structure, the end wall of the sound generation component 11 is a planar surface, and in this case, the end FE of the sound generation component 11 is an end sidewall of the sound generation component 11 that is disposed opposite to the fixed end connected to the suspension structure 12. As another example, when the sound generation component 11 is a sphere, an ellipsoid, or an irregular structural body, the end FE of the sound generation component 11 refers to a specific region away from the fixed end obtained by cutting the sound generation component 11 along an X-Z plane (a plane formed by the short axis direction Z and the thickness direction X), and a ratio of a dimension of the specific region along the long axis direction Y to a dimension of the sound generation component along the long axis direction Y is in a range of 0.05-0.2.

Referring to FIGS. 3A and 3B, an earhook is illustrated herein as an example of the suspension structure 12, and in some embodiments, the earhook 12 includes a first portion 121 and a second portion 122 sequentially connected. The first portion 121 is hung between a rear inner side of the ear 100 and the head of the user, and the second portion 122 extends toward a front outer side of the ear (a side of the ear departs from the head along the coronal axis) and connects the sound generation component, thereby fixing the sound generation component 11 at a position near the ear canal of the user without blocking the opening of the ear canal. In some embodiments, the first acoustic hole is disposed on the sidewall of the sound generation component 11 facing the auricle 100, thereby transmitting the sound generated by the diaphragm to the opening of the ear canal 101 of the user after the sound is exported out of the sound generation component 11.

As shown in FIG. 3B, in some embodiments, the first acoustic hole 112 in flow communication with the first acoustic cavity is disposed on an inner side IS of the housing to guide the sound generated by the first acoustic cavity out of the housing and then toward the ear canal so that the user hears the sound. One or more second acoustic holes 113 in flow communication with the second acoustic cavity may be disposed on other sides of the housing (e.g., an upper side US or a lower side LS, etc.) to export the sound generated by the second acoustic cavity and then interfere and cancel with the sound generated by the first acoustic hole 112 in the far field. In some embodiments, the second acoustic hole 113 is located farther away from the ear canal compared to the first acoustic hole 112 to attenuate the phase cancellation of the sound between the sound output through the second acoustic hole 113 and the sound output through the first acoustic hole 112 at a listening position.

By extending the sound generation component 11 at least partially into the concha cavity, a listening sound volume at the listening position (e.g., at the opening of the ear canal) is increased, especially at low and middle frequencies, while still maintaining a better phase cancellation of a far field sound leakage. Merely by way of example, when a whole or a portion of the structure of the sound generation component 11 extends into the concha cavity 102, the sound generation component 11 forms a cavity-like structure with the concha cavity 102, and, in the embodiment of the present disclosure, the cavity-like structure is understood to be a semi enclosed structure enclosed by the sidewall of the sound generation component 11 together with the structure of the concha cavity 102. The semi enclosed structure allows the listening position (e.g., at the opening of the ear canal) not completely isolated from an external environment, instead, the semi enclosed structure is a leakage structure (e.g., an opening, a slit, a tube, etc.) that is acoustically connected to the external environment. When the user wears the acoustic device 10, one or more first acoustic holes 112 may be disposed on a side of the housing of the sound generation component 11 proximate to or facing the ear canal of the user, and one or more second acoustic holes 113 are disposed on other sidewalls of the housing of the sound generation component 11 (e.g., sidewalls away from or depart from the ear canal of the user). The one or more first acoustic holes 112 are acoustically coupled to the first acoustic cavity of the acoustic device 10, and the one or more second acoustic holes 113 are acoustically coupled to a second acoustic cavity of the acoustic device 10. Taking the sound generation component 11 including the first acoustic hole 112 and the second acoustic hole 113 as an example, the sound output by the first acoustic hole 112 and the sound output by the second acoustic hole 113 are approximated to be considered as two sound sources, which have phases opposite to each other. The inner walls corresponding to the sound generation component 11 and the concha cavity 102 form a cavity-like structure. The sound source corresponding to the first acoustic hole 112 is disposed within the cavity-like structure, and the sound source corresponding to the second acoustic hole 113 is disposed outside the cavity-like structure, thereby forming an acoustic model shown in FIG. 4.

As shown in FIG. 4, the cavity-like structure 402 may contain the listening position and at least one sound source 401A. The “contain” herein may mean that at least one of the listening position and the sound source 401A is inside the cavity-like structure 402, or that at least one of the listening position and the sound source 401A is at an inner edge of the cavity-like structure 402. The listening position may be equated to an entrance of the ear canal or within the ear canal, or may be an acoustic reference point in the ear, such as an ear reference point (ERP), an ear-drum reference point (DRP), etc., or may be an entrance structure oriented to the listener, etc. A sound source 401B is located outside the cavity-like structure 402, and the sound sources 401A and 401B with opposite phases respectively radiate the sound to a surrounding space and undergo an interference cancellation phenomenon of sound waves, to realize an effect of sound leakage cancellation. Specifically, as the sound source 401A is wrapped by the cavity-like structure 402, most of the sound radiated therefrom reaches the listening position by direct emission or reflection. Relatively, when there is no cavity-like structure 402, most of the sound radiated from the sound source 401A does not reach the listening position. Thus, the cavity structure is disposed in such a way that a sound volume that reaches the listening position is significantly increased. At the same time, only a small portion of the sound with an opposite phase radiated by an anti-phase sound source 401B outside the cavity-like structure 402 enters the cavity-like structure 402 through a leakage structure 403 of the cavity-like structure 402. This equals to a generation of a secondary sound source 401B′ at the leakage structure 403, which is significantly less intense than the sound source 401B, and significantly less intense than the sound source 401A. The sound generated by the secondary sound source 401B′ has a weak opposite phase canceling effect on the sound source 401A within the cavity, resulting in a significant increase in the listening sound volume at the listening position. For the sound leakage, the sound source 401A radiates sound to the outside world through the leakage structure 403 of the cavity, which is equivalent to generating a secondary sound source 401A′ at the leakage structure 403, as almost all of the sound radiated by the sound source 401A is output from the leakage structure 403, and a scale of the cavity-like structure 402 is much smaller than a spatial scale for evaluating the sound leakage (with a difference of at least an order of magnitude). Therefore, the secondary sound source 401A′ may be considered to be of comparable intensity to the sound source 401A and a comparable sound leakage reduction effect is still maintained.

In some embodiments of the present disclosure, the cavity-like structure that is in flow communication with the outside world between the sound generation component 11 and a contour of the concha cavity is formed by extending the sound generation component 11 partially or integrally into the concha cavity. Further, by disposing the first acoustic hole 112 on the housing of the sound generation component facing the opening of the ear canal of the user and near an edge of the concha cavity, the acoustic model illustrated in FIG. 4 is constructed, which allows the user to hear a greater sound volume while wearing the acoustic device. In other words, by specially designing the structure and the wearing manner etc. of the sound generation component, the sound generation component 11 has a superior sound output efficiency. The superior sound output efficiency described herein may mean that even if a smaller input signal is disposed to the sound generation component 11 (e.g., a smaller input voltage or input power is disposed to the diaphragm of the sound generation component 11), the sound generation component may still be able to dispose the user with a sufficiently great sound volume, i.e., a sound pressure that is generated within the ear canal of the user that exceeds a specific threshold.

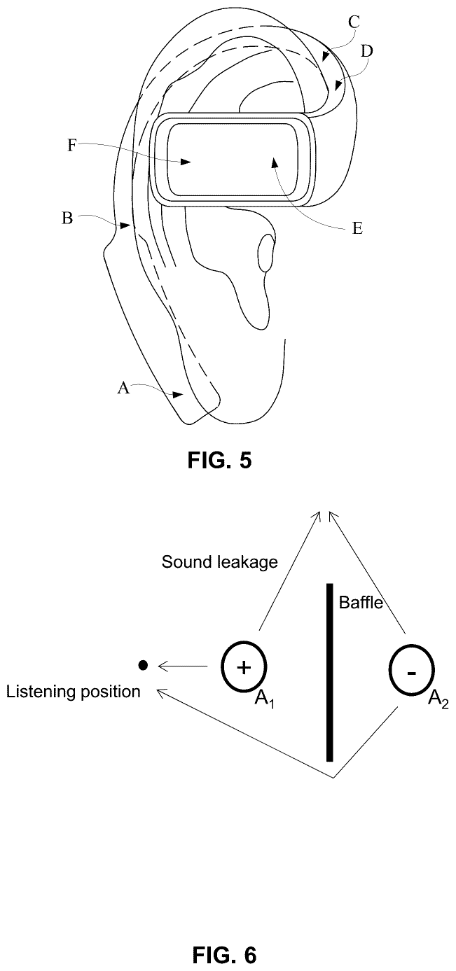

In some embodiments, the sound generation component has a wearing manner different from the manner of extending into the concha cavity in FIG. 3A, and a superior sound output efficiency is also achieved. The following is a detailed description of an exemplary acoustic device 10 as shown in FIG. 5.

FIG. 5 is a schematic diagram illustrating an exemplary acoustic device in a wearing state according to some other embodiments of the present disclosure.

In some embodiments, when the acoustic device 10 is in a wearing state, at least a portion of the sound generation component 11 covers an antihelix region of a user. At this time, the sound generation component 11 is located above the concha cavity 102 and the opening of the ear canal, and the opening of the ear canal of the user is in an open state. In some embodiments, a housing of the sound generation component 11 includes at least one of the first acoustic hole 112 and the second acoustic hole 113. The first acoustic hole 112 is acoustically connected to a first acoustic cavity of the acoustic device 10. The second acoustic hole 113 is acoustically coupled to a second acoustic cavity of the acoustic device 10. A sound output from the first acoustic hole 112 and a sound output from the second acoustic hole 113 are approximately regarded as two sound sources with opposite phases. When the user wears the acoustic device, the first acoustic hole 112 is disposed on a sidewall of the sound generation component 11 facing or near an opening of an ear canal of the user, and the second acoustic hole 113 is disposed on the sidewall of the sound generation component 11 away from or departs from the opening of the ear canal of the user. At this time, the sound generation component 11 and the auricle of the user may be considered as a baffle structure. The sound source corresponding to the first acoustic hole 112 is located on one side of the baffle, and the sound source corresponding to the second acoustic hole 113 is located on the other side of the baffle after bypassing the sound generation component 11 and the auricle to form the acoustic model shown in FIG. 6.

As shown in FIG. 6, when there is a baffle between a sound source A1 and a sound source A2, in a near field, a sound field of the sound source A2 needs to bypass the baffle to interfere with sound waves of the sound source A1 at a listening position, which is equivalent to increasing a sound path of the sound source A2 to the listening position. As a result, assuming that the sound source A1 and the sound source A2 have the same amplitude, an amplitude difference between the sound waves of the sound source A1 and the sound source A2 at the listening position is increased compared to a situation where the baffle is not disposed, thus a degree of phase cancellation of the two sounds at the listening position is reduced, resulting in an increase in the sound volume at the listening position. In the far field, as the sound waves from both the sound source A1 and the sound source A2 may interfere over a greater spatial range without bypassing the baffle (similar to the situation with no baffle), a sound leakage in the far field does not increase significantly compared to the situation without baffle. Therefore, disposing the baffle structure around one of the sound source A1 and the sound source A2 allows for a significant increase in the sound volume at a near-field listening position without a significant increase in the sound volume of the sound leakage in the far field.

Some embodiments of the present disclosure enable the user to hear a greater listening sound volume while wearing the acoustic device by covering at least a portion of the sound generation component 11 over the region of the antihelix of the user. In this way, the sound generation component 11 may have a superior sound output efficiency.

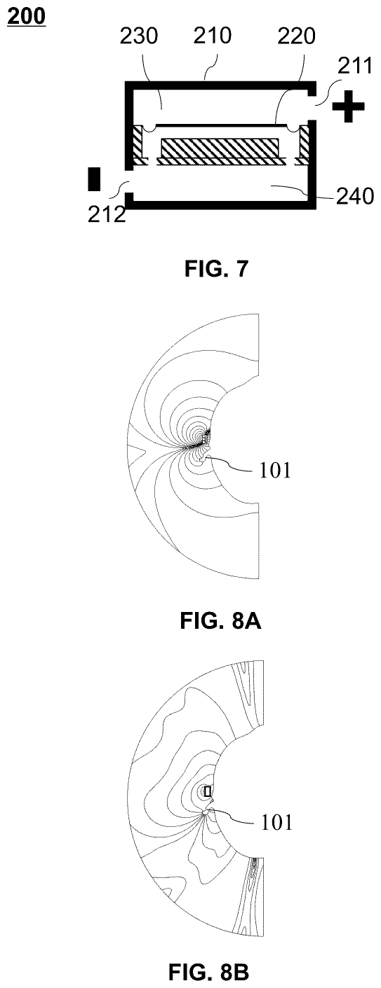

FIG. 7 is a schematic diagram illustrating an acoustic device according to some embodiments of the present disclosure. As shown in FIG. 7, an acoustic device 200 may include a housing 210 and a diaphragm 220. The diaphragm 220 may be disposed within a cavity formed by the housing 210, and the diaphragm 220 is disposed with a first acoustic cavity 230 and a second acoustic cavity 240 for radiating a sound on front and rear sides, respectively. The housing 210 is disposed with a first acoustic hole 211 and a second acoustic hole 212. The first acoustic cavity 230 may be acoustically coupled to the first acoustic hole 211, and the second acoustic cavity 240 may be acoustically coupled to the second acoustic hole 212. When a user wears the acoustic device 200, the acoustic device 200 may be located near an auricle of the user, and the first acoustic hole 211 may face an opening of an ear canal of the user. The second acoustic hole 212 may be located away from the opening of the ear canal relative to the first acoustic hole 211, and a distance between the first acoustic hole 211 and the opening of the ear canal may be less than a distance between the second acoustic hole 212 and the opening of the ear canal.

In some embodiments, the front and rear sides of the diaphragm 220 each acts as a sound wave generation structure, thereby producing a group of sound waves (or sounds) of equal amplitude and (approximately) opposite phases. In some embodiments, the group of sound waves of equal amplitude and opposite phase radiates outwardly through the first acoustic hole 211 and the second acoustic hole 212, respectively. When the diaphragm 220 outputs the sound waves, the sound waves on the front side of the diaphragm 220 (or referred to as first sound waves) may be emitted from the first acoustic hole 211 through the first acoustic cavity 230, and the sound waves on the rear side of the diaphragm 220 (or referred to as second sound waves) may be emitted from the second acoustic hole 212 through the second acoustic cavity 240, thereby forming a dual sound source that includes the first acoustic hole 211 and the second acoustic hole 212. The dual sound source may undergo an interference cancellation at a spatial point (e.g., a far field), thereby effectively reducing a sound leakage of the acoustic device 200 in the far field.

FIG. 8A is a schematic diagram illustrating a sound field distribution of the acoustic device shown in FIG. 7 at low and medium frequencies. As shown in FIG. 8A, in low and middle frequency ranges (e.g., 50 Hz-1 kHz), the sound field distribution of the acoustic device 200 in a region of the ear 100 shows a good directivity. In this situation, a sound field region with a higher sound pressure is distributed close to the opening of the ear canal 101, and the sound field region with a lower sound pressure is distributed far away from the opening of the ear canal 101, which results in a significant effect of sound leakage reduction. That is, in the low and medium frequency range, dual sound source constituted by the first acoustic hole 211 and the second acoustic hole 212 of the acoustic device 200 output sound waves with opposite phases or approximately opposite phases, and according to a principle of the sound wave cancellation, the two sound waves cancel each other in a far field, thereby realizing the effect of sound leakage reduction in the far field.

FIG. 8B is a schematic diagram illustrating a sound pressure level sound field distribution of the acoustic device shown in FIG. 7 at a high frequency. As shown in FIG. 8B, the sound field distribution of the acoustic device 200 is more chaotic in a higher frequency range. In some embodiments, in the high frequency range (e.g., 1500 Hz-20 kHz), wavelengths of the first sound wave and the second sound wave are shorter than wavelengths in the low and medium frequency ranges. At this time, a distance between dual sound source constituted by the first acoustic hole 211 and the second acoustic hole 212 is not negligible relative to the wavelengths, which results in that sound waves emitted by the two sound sources is unable to be canceled out. As a result, it is difficult to ensure a sound leakage reduction effect of the sound generation component in a far field in the higher frequency range, and the sound leakage is even increased, making the sound field distribution of the sound generation component more chaotic. For illustrative purposes only, a distance between the first acoustic hole 211 and the second acoustic hole 212 makes sound paths from a first sound wave and a second sound wave to a certain spatial point (e.g., a far field) different, thereby making a phase difference of the first sound wave and the second sound wave at the spatial point smaller (e.g., the phase is the same or approximately the same), so that the first and second sound waves are unable to interfere and cancel at the spatial point. Alternatively, the first sound wave and the second sound wave may be superimposed at the spatial point to increase an amplitude of the sound waves at the point of space, leading to an increased sound leakage.

In some embodiments, the sound waves emitted from front and rear sides of the diaphragm 220 first passes through an acoustic transmission structure before radiating outwardly from the first acoustic hole 211 and/or the second acoustic hole 212. The acoustic transmission structure refers to an acoustic path through which the sound waves are radiated from the diaphragm 220 to an outside environment. In some embodiments, the acoustic transmission structure includes the housing 210 between the diaphragm 220 and the first acoustic hole 211 and/or the second acoustic hole 212. In some embodiments, the acoustic transmission structure includes an acoustic cavity (including the first acoustic cavity 230 and the second acoustic cavity 240). In some embodiments, the acoustic transmission structure is acoustically connected to the first acoustic hole 211 and/or the second acoustic hole 212, and the first acoustic hole 211 and/or the second acoustic hole 212 is a portion of the acoustic transmission structure. In some embodiments, when a radiation direction of the sound waves generated by the diaphragm 220 is not directed in an expected direction or away from an opening of an ear canal, the sound wave are directed to the expected direction through a sound guiding tube, and then the first acoustic hole 211 and/or the second acoustic hole 212 radiate to the external environment, whereby the acoustic transmission structure also includes the sound guiding tube.

In some embodiments, the acoustic transmission structure has a resonance frequency, and the acoustic transmission structure resonates when a frequency of the sound wave generated by the diaphragm 220 is close to the resonance frequency. Under an action of the acoustic transmission structure, the sound waves in the acoustic transmission structure also resonate, the resonance changes a frequency component of the transmitted sound waves (e.g., by adding additional resonance peaks to the transmitted sound waves) or changes a phase of the transmitted sound waves in the acoustic transmission structure. Compared to a situation where no resonance occurs, the phase and/or the amplitude of the sound waves radiated from the first acoustic hole 211 and/or the second acoustic hole 212 change, resulting in sound field chaos of the dual sound source structure near the resonance frequency, affecting the effect of interference cancellation of the sound waves radiated from the first acoustic hole 211 and the second acoustic hole 212 at the spatial point. For example, when the resonance occurs, the phase difference between the sound waves radiated by the first acoustic hole 211 and the second acoustic hole 212 changes, and for example, when the phase difference between the sound waves radiated by the first acoustic hole 211 and the second acoustic hole 212 is small (e.g., less than 120°, less than 90°, 0, etc.), the effect of interference cancellation of the sound waves at the spatial point is weakened, and it is difficult to achieve the effect of sound leakage reduction. Alternatively, the sound waves with the small phase difference may superimpose on each other at the spatial point, thereby increasing the amplitude of the sound waves near the resonance frequency at the spatial point (e.g., the far field), and increasing the far-field sound leakage of the acoustic device 200. As another example, the resonance causes the amplitude of the transmitted sound waves to increase near the resonance frequency of the acoustic transmission structure (e.g., manifested as a resonance peak near the resonance frequency), resulting in a chaotic acoustic field near the resonance frequency of the dual acoustic source structure. At this time, the amplitude of the sound waves radiated from the first acoustic hole 211 and the second acoustic hole 212 differ considerably, and the interference cancellation effect of the sound waves at the spatial point is reduced, making it difficult to reduce the sound leakage. In some embodiments, differences in parameters such as volumes of the first acoustic cavity 230 and the second acoustic cavity 240 of the sound generation component, and sizes and heights of the first acoustic hole 211 and the second acoustic hole 212 lead to inconsistencies in the resonance frequencies of the first acoustic cavity 230 and the second acoustic cavity 240 (which are referred to simply as the acoustic cavities), that is, lead to different resonance frequencies of the acoustic transmission structures at the front and rear sides of the acoustic device 200. In some embodiments, an effect of the structures such as the ear 100 on the blocking and/or reflection of the sound waves in high frequency also results in a chaotic sound field distribution of the acoustic device 200.

Based on the descriptions of FIGS. 7-8B, the dual sources have a chaotic sound field in the high frequency range, with a poor leakage reduction, and in some cases may even increase the sound leakage. To improve the sound leakage reduction effect of the acoustic device in the high frequency range, a sound absorbing structure may be disposed in the second acoustic cavity of the acoustic device. The sound absorbing structure may absorb the sound waves in a target frequency range in the second acoustic cavity, so as to reduce or avoid the superposition of the first sound wave and the second sound wave at the spatial point (e.g., the far field) outside the acoustic device, reduce the amplitudes of the sound waves in the target frequency range at the spatial point, and adjust a directivity of the acoustic device to realize the effect of sound leakage reduction in the far field.

The sound absorbing structure refers to a structure that absorbs the sound waves in a specific frequency band (e.g., in the target frequency range). The sound absorbing structure may be coupled to the second sound cavity for absorbing the sound in the target frequency range radiated through the second acoustic cavity to the second acoustic hole. Correspondingly, in the target frequency range, a sound pressure level at the second acoustic hole without the sound absorbing structure is greater than the sound pressure level at the second acoustic hole with the sound absorbing structure.

In some embodiments, the target frequency range includes a frequency range near the resonant frequency of the second acoustic cavity. The sound absorbing structure is capable of absorbing the sound waves near the resonance frequency of the second acoustic cavity to avoid a change in the phase and/or amplitude of the second sound wave caused by the resonance of the second acoustic cavity near the resonance frequency, and thereby reducing the amplitude of the sound wave near the resonance frequency, and ensuring the sound leakage reduction effect of the acoustic device 200. In some embodiments, the resonance frequency occurs in middle and high frequency band, e.g., 2 kHz-8 KHz. Correspondingly, the target frequency range includes frequencies in the middle and high frequency band. For example, the target frequency range is in a range of 1 kHz-10 KHz. In some embodiments, at a higher frequency range, due to the non-negligible distance between the dual acoustic sources including the first acoustic hole and the second acoustic hole relative to the wavelength, the first sound wave and the second sound wave at the spatial point are unable to interfere and cancel each other, and are superimposed at the spatial point, thereby increasing the amplitude of the sound wave at the spatial point. In some embodiments, to reduce the amplitude of the sound wave increased by the superposition of the first and second sound waves in the higher frequency range, the target frequency range also includes frequencies greater than the resonant frequency. In such cases, the sound absorbing structure may absorb the sound waves in the higher frequency range to reduce or avoid the superposition of the first and second sound waves at the spatial point, thereby reducing the amplitude of the sound waves in the target frequency range at the spatial point. For example, the target frequency range is in a range of 1 kHz-20 KHz. It should be noted that the resonant frequency of the second acoustic cavity may be obtained by various testing manners. For example, when testing a frequency response curve of the second acoustic cavity without the sound absorbing structure, by keeping the first acoustic hole open, the frequency response curve at the position of the second acoustic hole is tested using a microphone device (e.g., by placing the microphone device at a position of 2 mm-5 mm in front of the second acoustic hole), and a resonant frequency corresponding to the resonant peak on the frequency response curve is obtained.

In some embodiments, by disposing the sound absorbing structure (e.g., a position and an absorbing frequency, etc. of the sound absorbing structure), the acoustic device has a different sound effect at the spatial point. In some embodiments, the resonance of the first acoustic cavity also affects the sound wave radiation of the second acoustic cavity, an extra resonance peak is generated in the frequency response curve measured at the position of the second acoustic hole. To avoid adding the extra resonance peak to the sound wave transmitted by the second acoustic cavity due to the resonance of the first acoustic cavity, the target frequency range also includes the resonance frequency of the first acoustic cavity. In some embodiments, another sound absorbing structure is disposed in the first acoustic cavity for absorbing the sound waves near the resonance frequency of the first acoustic cavity to avoid an interference enhancement at the spatial point between the sound wave near the resonance frequency of the first acoustic cavity and the sound wave in the same frequency range output by the second acoustic hole, thereby reducing the amplitude of the sound waves near the resonance frequency of the first acoustic cavity received at the spatial point. In some embodiments, the sound absorbing structure is disposed in both the first acoustic cavity and the second acoustic cavity such that the sound waves near the resonant frequencies of the first and second sound waves are absorbed, which allows for a better reduction of the amplitude of the sound wave at any spatial point. In some embodiments, the sound absorbing structure also absorbs the low frequency sound in a particular frequency range. For example, the sound absorbing structure is disposed in the second acoustic cavity to reduce the low frequency sounds of a particular frequency range output from the second acoustic hole to avoid interference and cancellation between the low frequency sound of the particular frequency range and the low frequency sound of the same frequency range output from the first acoustic hole at the spatial point (e.g., in the near field), thereby increasing the sound volume of the acoustic device in the near field (i.e., to the ear of the user) in that particular frequency range. In some embodiments, the sound absorbing structure also includes sub-sound absorbing structures for absorbing different frequency ranges, e.g., the sub-sound absorbing structures absorbing sounds of a middle and high frequency band and a low frequency band for absorbing sound in different frequency ranges, respectively.

In some embodiments, as the wavelength of the high frequency sound wave is shorter in the high frequency range greater than the resonant frequency of the second acoustic cavity, a distance between the two acoustic holes (e.g., a distance between geometric centers of the two acoustic holes) affects the phase difference between the sound waves radiated by the two acoustic holes at the spatial point, which results in the dual sound source formed by the two acoustic holes having a weakened sound leakage reduction effect in the high frequency range. In such cases, to reduce a high frequency output of the second acoustic cavity, the target frequency range may include a high frequency range greater than the resonance frequency of the second acoustic cavity, so as to enable the sound absorbing structure to absorb the high frequency sound wave, thereby solving a problem of unsatisfactory sound leakage reduction in the high frequency range of the dual sound source.

As a human ear is relatively sensitive to the sounds in a range of 3 kHz-6 kHz near the resonant frequency and in the higher frequency range, in some embodiments, the target frequency range includes the frequency range of 3 KHz-6 KHz for a more targeted and effective sound leakage reduction. In some embodiments, the target frequency range includes 4 kHz-6 kHz. In some embodiments, the target frequency range includes sounds that are less than the resonant frequency. For example, the human ear is most sensitive to sounds near 1 kHz-3 kHz, and thus the target frequency range includes a frequency range of 1 kHz-3 kHz. It should be noted that the resonance frequency herein refers primarily to a resonance frequency of the second acoustic cavity, and in some embodiments refers to a resonance frequency of the second acoustic cavity or a resonance frequency of the first acoustic cavity, hereinafter referred to as the resonance frequency.

According to the above embodiments, the sound absorbing structure absorbs the sound waves in the target frequency range of the first sound wave and/or the second sound wave, thereby reducing the amplitude of the sound waves in the target frequency range at the spatial point. Whereas for the first sound wave and the second sound wave outside the target frequency range (e.g., the sound wave smaller than the resonance frequency), the first sound wave and the second sound wave are transmitted through the acoustic transmission structure to the spatial point and interfere at the spatial point. The interference may reduce an amplitude of the sound wave at that spatial point that lies outside the target frequency range. That is, the first sound wave and the second sound wave outside the target frequency range (or referred to as the first frequency range) may interfere and cancel at the spatial point, to realize the sound leakage reduction effect of the dual sound source. The first sound wave and/or the second sound wave within the target frequency range (or referred to as the second frequency range) may be absorbed by the sound absorbing structure, and thus an interference enhancement of the first sound wave and/or the second sound wave at the spatial point may be reduced or avoided. Alternatively, the additional resonance peak generated by the first sound wave or the second sound wave under the action of the acoustic transmission structure may be attenuated or absorbed, which in turn reduces the amplitude of the sound wave in the target frequency range at the spatial point. As a result, in the embodiments of the present disclosure, by disposing the sound absorbing structure, the acoustic device is made to output the first sound wave and the second sound wave in the first frequency range, and the sound wave output of the acoustic device (e.g., the second acoustic hole) near or higher than the resonant frequency is reduced, which ensures that the acoustic device has an interference cancellation effect in the first frequency range, while reducing or avoiding an increase of the amplitude of the sound wave in the second frequency range at the spatial point (e.g., the far field). As a result, the directivity of the acoustic device is adjusted to ensure the sound leakage reduction effect in a full frequency range.

A sound absorbing effect of the sound absorbing structure is an amount of sound that the sound absorbing structure is able to absorb in the target frequency range, which is expressed in terms of the sound pressure level of the sound. For example, the sound absorbing effect of the sound absorbing structure is expressed as a difference between the sound pressure levels measured at the same frequency and at the same position corresponding to the second acoustic cavity, respectively, in the target frequency range, when there is the sound absorbing structure and when there is not the sound absorbing structure. Merely by way of example, the difference between the sound pressure levels at the second acoustic hole with and without the sound absorbing structure is used to express the difference between the sound pressure levels at the second acoustic cavity with and without the sound absorbing structure. Merely by way of example, the sound pressure levels at the second acoustic cavity with and without the sound absorbing structure are measured by placing a test microphone directly in front of the second acoustic cavity, at a distance of about 2 mm-5 mm, and testing the sound pressure levels at the second acoustic cavity with and without the sound absorbing structure. A test frequency is near the resonance frequency of the second acoustic cavity or near 1 kHz. In some embodiments, the difference between the sound pressure levels measured at the same frequency and at the same position within the second acoustic cavity, respectively, with and without the sound absorbing structure, is no less than 3 dB. For example, when there is the sound absorbing structure and there is not the sound absorbing structure, the difference between the sound pressure levels at the second acoustic hole measured at the same frequency is not less than 3 dB. In some embodiments, the target frequency range described above is referred to as a sound absorbing bandwidth of the sound absorbing structure. When the sound absorbing bandwidth is in a range of 3 kHz-6 kHz, the sound absorbing structure may effectively absorb the sound waves in the range of 3 kHz-6 kHz with a sound absorbing effect of not less than 3 dB, which improves the sound leakage of the acoustic device in the range of 3 kHz-6 kHz. In some embodiments, to further reduce the sound leakage of the acoustic device, in the target frequency range, the sound absorbing effect of the sound absorbing structure is not less than 5 dB. In some embodiments, to further reduce the sound leakage of the acoustic device, the sound absorbing effect of the sound absorbing structure is no less than 6 dB in the target frequency range. In some embodiments, to further reduce the sound leakage of the acoustic device, the sound absorbing effect of the sound absorbing structure is no less than 8 dB in the target frequency range. In some embodiments, to further reduce the sound leakage from the acoustic device, the sound absorbing effect of the sound absorbing structure is no less than 10 dB in the target frequency range. In some embodiments, the sound absorbing effects of the sound absorbing structure is different in different frequency ranges. For example, the sound absorbing effect of the sound absorbing structure is not less than 3 dB in a range of 3 kHz-6 kHz. As another example, the sound absorbing effect of the sound absorbing structure is not less than 6 dB in a range of 4 kHz-6 KHz. As another example, in a range of 5 kHz-6 kHz, the sound absorbing effect of the sound absorbing structure is no less than 8 dB, which allows for a more effective reduction of the sound leakage in higher frequency ranges.

As a frequency response curve of the second acoustic cavity has a resonance peak at a specific frequency thereof (e.g., the resonance frequency), and a vibration amplitude at the resonance frequency is greater, to obtain a better sound leakage reduction effect at the resonance frequency of the second acoustic cavity, the sound absorbing structure needs to absorb more sound at the resonance frequency. In such cases, in some embodiments, the sound absorbing structure has an absorbing effect of not less than 14 dB for the sound at the resonance frequency or the sound whose vibration frequency is near the resonance frequency. In this way, the sound wave at or near the resonance frequency of the second acoustic cavity may be absorbed by the sound absorbing structure, thereby reducing or avoiding the resonance near the resonance frequency under the action of acoustic cavity, thus reducing or avoiding changes of the amplitude difference and the phase difference between the first and the second sound waves, which leads to a situation where the sound leakage reduction effect at the spatial point is worsening, or the two groups of sounds interfere more intensively instead of canceling each other, and reducing the sound leakage of the acoustic device at the spatial point in the far field. In some embodiments, to further reduce the sound leakage of the acoustic device, the sound absorbing structure has a sound absorbing effect of not less than 16 dB on the sound at the resonance frequency or a sound whose vibration frequency nears the resonance frequency. In some embodiments, to further reduce the sound leakage of the acoustic device, the sound absorbing structure has a sound absorbing effect of not less than 18 dB on the sound at the resonance frequency or the sound whose vibration frequency nears the resonance frequency. In some embodiments, to further reduce the sound leakage of the acoustic device, the sound absorbing structure has a sound absorbing effect of not less than 20 dB on the sound at the resonance frequency or the sound whose vibration frequency nears the resonance frequency. In some embodiments, to further reduce the sound leakage of the acoustic device, the sound absorbing structure has a sound absorbing effect of not less than 22 dB on the sound at the resonance frequency or the sound whose vibration frequency nears the resonance frequency. In some embodiments, to further reduce the sound leakage of the acoustic device, the sound absorbing structure has a sound absorbing effect of not less than 25 dB on the sound at the resonance frequency or the sound whose vibration frequency nears the resonance frequency.

In some embodiments, the sound absorbing structure includes at least one of a resistive sound absorbing structure or an anti-sound absorbing structure. For example, the sound absorbing structure is realized by the resistive sound absorbing structure. For example, a function of the sound absorbing structure is realized by an anti-sound sound absorbing structure. As another example, the function of the sound absorbing structure is realized by the sound absorbing structure that mixes the resistive sound absorbing structure and the anti-sound sound absorbing structure.

The resistive sound absorbing structure refers to a structure capable of providing an acoustic resistance when the sound waves pass through. In some embodiments, the resistive sound absorbing structure includes at least one of a porous acoustic material or an acoustic gauze. In some embodiments, the resistive sound absorbing structure is disposed anywhere along a transmission path of the first sound wave and/or the second sound wave. For example, the porous acoustic material or the acoustic gauze is affixed to an interior wall of the acoustic transmission structure. As another example, the porous sound absorbing material or the acoustic gauze forms at least a portion of an inner wall of the acoustic transmission structure. As another example, the porous sound absorbing material or the acoustic gauze fills at least a portion of the interior of the acoustic transmission structure. The anti-sound structure refers to a structure that absorbs the sound by utilizing resonance. In some embodiments, the resistive sound absorbing structure includes, but is not limited to, a Helmholtz sound absorbing cavity, a perforated plate sound absorbing structure, a microperforated plate sound absorbing structure, a thin plate, a thin film, a ¼-wavelength resonance tube, etc., or any combination thereof. In some embodiments, both the resistive sound absorbing structure and the anti-sound absorbing structure are disposed as an impedance-hybrid sound absorbing structure to realize the function of the sound absorbing structure. For example, the impedance-hybrid sound absorbing structure includes a microperforated plate sound absorbing structure and a porous sound absorbing material or the acoustic gauze. The porous sound absorbing material or the acoustic gauze is disposed in a cavity of the microperforated plate structure or inside the acoustic transmission structure. As another example, the impedance-hybrid sound absorbing structure includes a ¼-wavelength resonance tube structure and the porous sound absorbing material or the acoustic gauze. The ¼-wavelength resonance tube structure is disposed inside or outside the acoustic transmission structure, and the porous sound absorbing material or the acoustic gauze is disposed within the acoustic transmission structure. As another example, the impedance-hybrid sound absorbing structure includes the microperforated plate sound absorbing structure, the ¼-wavelength resonance tube structure, and the porous sound absorbing material or the acoustic gauze.

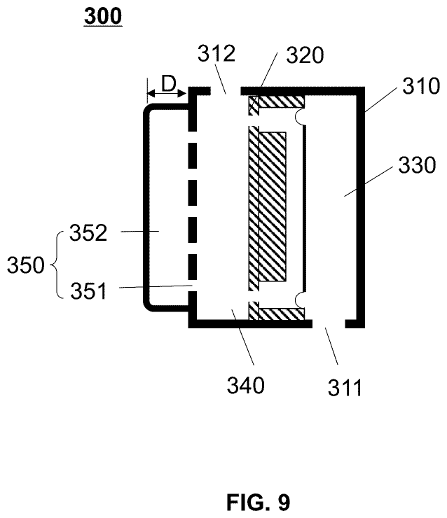

The sound absorbing structure is coupled to the second acoustic cavity. In some embodiments, the sound absorbing structure includes the microperforated plate sound absorbing structure. The microperforated plate sound absorbing structure includes a microperforated plate and a cavity, and the microperforated plate includes through holes. The acoustic cavity coupled to the microperforated plate structure is in flow communication with the cavity through the through holes on the microperforated plate. M ore contents on the microperforated plate sound absorbing structure may be found elsewhere in the present disclosure, for example, in FIG. 9 and the corresponding descriptions.

In some embodiments of the present disclosure, by setting the sound absorbing structure coupled with the second acoustic cavity, the sound waves in the target frequency range are absorbed by the sound absorbing structure, and the resonance occurring near a specific frequency (e.g., the resonance frequency) under the action of the acoustic cavity may be reduced or avoided, thereby reducing or avoiding the changes of the amplitude difference and the phase difference between the first sound wave and the second sound wave near a specific frequency in the acoustic cavity (which results in a poor sound leakage effect at the spatial point, or even a situation where the two group of sounds interfere with each other instead of canceling each other). As a result, the sound leakage in the target frequency range is reduced. The first and second sound waves outside of the target frequency range may be canceled to reduce the sound leakage at the spatial point.

In some embodiments, to reduce the sound leakage of the acoustic device 10 in the far field, an intensity of the first sound leakage and an intensity of the second sound leakage as described above should be close to each other while being in opposite or approximately opposite phases. Therefore, acoustic loads (or the acoustic resistances) of the first acoustic hole 112 and the second acoustic hole 113 may be close. In some embodiments, to make the acoustic loads of the first acoustic hole 112 and the second acoustic hole 113 to be close to each other, open areas of the first acoustic hole 112 and the second acoustic hole 113 are close to each other. In some embodiments, a ratio of the open area of the first acoustic hole 112 to the open area of the second acoustic hole 113 is in a range of 0.5-2. In some embodiments, to make the acoustic loads of the first acoustic hole 112 and the second acoustic hole 113 comparable and to make the open area of the first acoustic hole 112 sufficiently great for user listening, the ratio of the open area of the first acoustic hole 112 to the open area of the second acoustic hole 113 is in a range of 1.0-1.8. In some embodiments, to make the acoustic loads of the first acoustic hole 112 and the second acoustic hole 113 comparable and to make the open area of the second acoustic hole 113 sufficiently great to ensure the far field sound leakage reduction effect, the ratio of the open area of the first acoustic hole 112 to the open area of the second acoustic hole 113 is in a range of 0.5-0.9. When there are two or more second acoustic holes 113, the open area of the second acoustic hole 113 is a total open area of the plurality of second acoustic holes 113. In some embodiments, the acoustic loads of the first acoustic hole 112 and the second acoustic hole 113 are brought close by setting other parameters of the first acoustic hole 112 and the second acoustic hole 113. For example, a sound resistance mesh is disposed at the first acoustic hole 112 and at the second acoustic hole 113, respectively, and the sound resistance meshes have the same or close sound resistances.

In some embodiments, to make the intensity of the first sound leakage close to the intensity of the second sound leakage, a difference between the acoustic load of the first acoustic hole 112 and the acoustic load of the second acoustic hole 113 is less than 0.15. In some embodiments, to make the intensity of the first sound leakage close to the intensity of the second sound leakage, the difference between the acoustic load of the first acoustic hole 112 and the acoustic load of the second acoustic hole 113 is less than 0.1. In some embodiments, to make the intensity of the first sound leakage further close to the intensity of the second sound leakage, the difference between the acoustic load of the first acoustic hole 112 and the acoustic load of the second acoustic hole 113 is less than 0.05. In some embodiments, there are one or more second acoustic holes 113. When there are two or more second acoustic holes 113, the acoustic loads of the second acoustic holes 113 refer to a sum of the acoustic loads of the plurality of second acoustic holes 113.

In some embodiments, the acoustic loads of the first acoustic hole 112 and the second acoustic hole 113 are close enough, and the sound generated by the second acoustic cavity that radiates outwardly (e.g., to the far field) through the second acoustic hole 212 is not negligible. In some embodiments, when the sound waves radiated outwardly by the second acoustic cavity pass through the acoustic transmission structure between the diaphragm and the second acoustic hole 113, a resonance of the acoustic transmission structure makes the sound waves in the acoustic transmission structure resonate as well. Compared to a situation where no resonance occurs, the phase and/or the amplitude of the sound waves radiated from the second acoustic hole 113 chances, which leads to chaos in the sound field of the sound generation component 11 near the resonance frequency, affecting the effect of interference and cancellation of the sound waves radiated from the first acoustic hole 112 and the second acoustic hole 113 in the far field. Accordingly, the sound waves in the second acoustic cavity need to be adjusted so that, without affecting the low frequency output of the second acoustic cavity, the output of the second acoustic cavity in the target frequency range (e.g., including the resonance frequency of the acoustic transmission structure) is reduced to reduce an effect of far field sound leakage. For example, the sound absorbing structure is disposed for absorbing the sound waves of the second acoustic cavity in the target frequency range, thereby realizing the adjustment of the sound waves in the second acoustic cavity, and effectively reducing the far field sound leakage. In addition, in a frequency band outside the target frequency range (e.g., the low frequency band), the far field sound leakage may be effectively reduced by making the intensity of the first sound leakage and the intensity of the second sound leakage close to each other.

FIG. 9 is a schematic diagram illustrating a structure of an acoustic device disposed with a sound absorbing structure according to some embodiments of the present disclosure.

As shown in FIG. 9, in some embodiments, an acoustic device 300 may include a housing 310 and a diaphragm 320. The diaphragm 320 is disposed within an accommodation cavity formed by the housing 310, and the diaphragm 320 is disposed with a first acoustic cavity 330 and a second acoustic cavity 340 on front and rear sides, respectively. The housing 310 is disposed with a first acoustic hole 311 and a second acoustic hole 312. The first acoustic cavity 330 may be acoustically coupled to the first acoustic hole 311, and the second acoustic cavity 340 may be acoustically coupled to the second acoustic hole 312.

In some embodiments, as shown in FIG. 9, the acoustic device 300 further includes a microperforated plate sound absorbing structure 350 coupled to the second acoustic cavity 340. In some embodiments, the microperforated plate sound absorbing structure 350 includes a microperforated plate 351 and a cavity 352. The microperforated plate 351 includes through holes. The second acoustic cavity 340 coupled to the microperforated plate structure is in flow communication with the cavity 352 through the through holes on the microperforated plate. It is appreciated that as shown in FIG. 9, the acoustic device 300 is only an exemplary illustration, and a specific manner in which the microperforated plate sound absorbing structure 350 is disposed may be changed or modified.

The sound waves of the second acoustic cavity 340 may enter the cavity 352 of the microperforated plate sound absorbing structure 350 through the one or more through holes and cause the microperforated plate sound absorbing structure 350 to resonate under specific conditions. For example, when a vibration frequency of the sound waves entering the cavity 352 is close to a resonant frequency of the microperforated plate sound absorbing structure 350, the sound waves entering the cavity 352 causes the resonance of the microperforated plate sound absorbing structure 350. Air in the cavity 352 resonates with the microperforated plate sound absorbing structure 350 and dissipates energy to realize a sound absorbing effect, and the frequency of the sound waves absorbed by the microperforated plate sound absorbing structure 350 may be the same or close to the resonant frequency of the microperforated plate sound absorbing structure 350.

In some embodiments, a material of the microperforated plate 351 is metal (e.g., aluminum) or non-metal (e.g., acrylic, polycarbonate (PC), etc.). When the microperforated plate 351 is a non-metal plate, the non-metal plate has a relatively small heat conduction coefficient, and a process of the sound waves passing through the through holes may be considered as an adiabatic process. When the microperforated plate 351 is a metal plate, the heat conduction coefficient of the metal plate is greater, and the process of the sound wave passing through the through holes may be regarded as an isothermal process when hole diameters of the through holes are small. The conduction of heat represents an enhancement of the energy dissipation, thus an equivalent damping of the metal plate is greater than an equivalent damping of the non-metal plate.

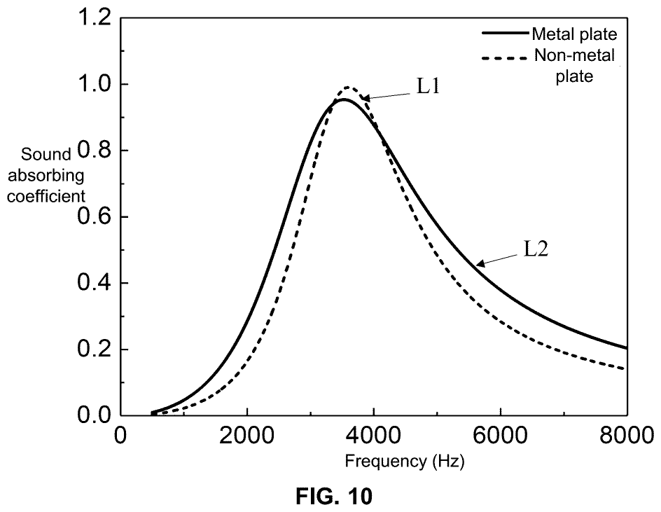

FIG. 10 is a schematic diagram illustrating sound absorbing effects of acoustic devices using a metal microperforated plate and a non-metal microperforated plate, respectively according to some embodiments of the present disclosure. A horizontal axis in FIG. 10 indicates a sound absorbing frequency, a vertical axis indicates a sound absorbing coefficient, a curve L1 indicates a sound absorbing effect of a non-metal microperforated plate, and a curve L2 indicates a sound absorbing effect of a metal microperforated plate. As shown in FIG. 10, a maximum sound absorbing coefficient of the metal microperforated plate is slightly lower than a maximum sound absorbing coefficient of the non-metal microperforated plate, but an absorbing bandwidth of the metal microperforated plate is wider than an absorbing bandwidth of the non-metal microperforated plate, as the metal microperforated plate has a better thermal conductivity and a greater equivalent damping for sound waves when passing through.

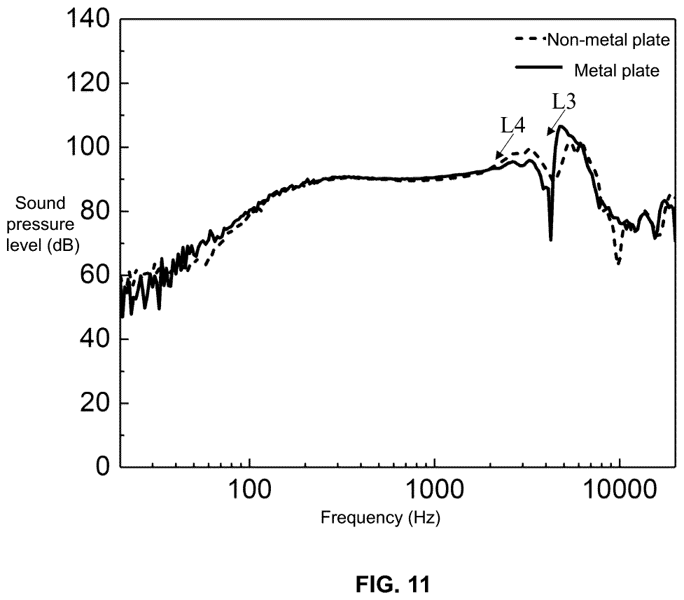

FIG. 11 is a graph illustrating frequency response curves of the acoustic device using metal and non-metal microperforated plates, respectively according to some embodiments of the present disclosure. In FIG. 11, a horizontal axis represents a frequency, a vertical axis represents a sound pressure level, and a curve L3 represents a frequency response of the acoustic device with the metal microperforated plate, and a curve L4 represents a frequency response of the acoustic device with the non-metal microperforated plate. The frequency response refers to a frequency response at a second acoustic hole (e.g., 10 mm directly in front of the second acoustic hole). As shown in FIG. 11, the metal microperforated plate has a better sound absorbing effect in low and medium frequency bands (e.g., less than 4 kHz) compared to the non-metal microperforated plate. A sound leakage of the acoustic device is reduced by about 2 dB-3 dB, and the metal microperforated plate is an aluminum plate. Although the sound absorbing effect of the non-metal microperforated plate is slightly worse, the use of the non-metal microperforated plate reduces a weight of the acoustic device, which is helpful for enhancing the portability of the acoustic device and reduces a cost of the acoustic device. In some embodiments, as the metal and non-metal plates have their own advantages, the metal and non-metal microperforated plates are flexibly chosen based on a variety of aspects, such as the weight, the cost, a corrosion resistance, etc.

If an intrinsic frequency of the microperforated plate 351 mounted in the acoustic device (or referred to as a fixed state) falls within a target frequency range, the microperforated plate 351 may resonate within the target frequency range, thereby affecting the sound absorbing effect. The intrinsic frequency of the microperforated plate 351 in the fixed state should therefore be much greater than the target frequency. In some embodiments, since the intrinsic frequency of the fixed state microperforated plate 351 is not readily measurable, the intrinsic frequency of the fixed state of the microperforated plate 351 is indicated by the intrinsic frequency of the microperforated plate 351 in a free state. The free state refers to a state of the microperforated plate 351 when the microperforated plate 351 is not mounted in the acoustic device, and the intrinsic frequency of the fixed state of the microperforated plate 351 is much greater than the intrinsic frequency in the free state. The measurement of the intrinsic frequency in the free state may be performed by keeping the microperforated plate 351 in the free state, applying an excitation force with a constant amplitude and a frequency varying from low to high to the microperforated plate 351 through an exciter, testing a speed amplitude of the microperforated plate 351 using a laser vibrometer, and recording a frequency at which the speed amplitude of the microperforated plate 351 first reaches a maximum value, i.e., the intrinsic frequency of the microperforated plate 351 in the free state. In some embodiments, a sound absorbing bandwidth is in a range of 3 kHz-6 KHz, and to prevent the intrinsic frequency in the fixed state of the microperforated plate from falling within the sound absorbing bandwidth, a theoretical value of the intrinsic frequency in the free state of the microperforated plate 351 is greater than 500 Hz (e.g., 500 Hz-3.6 kHz), which makes the intrinsic frequency in the fixed state much greater than the maximum frequency of the sound absorbing (i.e., the maximum frequency in the sound absorbing bandwidth, e.g., 6 kHz). The intrinsic frequency is related to a stiffness and a mass of the microperforated plate 351, and thus the intrinsic frequency may be determined by setting the stiffness and/or the mass of the microperforated plate 351 to enable the microperforated plate 351 to absorb the sound waves in the target frequency range. In some embodiments, the microperforated plates 351 of different shapes, materials, etc. have different stiffnesses and/or masses, resulting in different intrinsic frequencies. In some embodiments, the microperforated plate 351 has a regular shape such as a circle, a sector, a rectangle, a diamond, etc., or an irregular shape. In some embodiments, a material of the microperforated plate 351 is a non-metal or metal material.

In some embodiments, the microperforated plate 351 is a runway-type microperforated plate. In some embodiments, when the microperforated plate 351 is the runway-type microperforated plate, to have the intrinsic frequency of the microperforated plate 351 in the free state in a range of 500 Hz-3.6 kHz, the material has a Young's modulus range in a range of 5 Gpa-200 Gpa. For example, the Young's modulus of the material is in a range of 10 Gpa-180 Gpa. As another example, the Young's modulus of the material is in a range of 20 Gpa-150 Gpa. As another example, the Young's modulus of the material is in a range of 50 Gpa-100 Gpa. In some embodiments, a thickness of the microperforated plate 351 affects the intrinsic frequency of the microperforated plate 351. When the microperforated plate 351 is the runway-type microperforated plate, to make the intrinsic frequency of the microperforated plate 351 in the free state in a range of 500 Hz-3.6 kHz, the plate thickness of the runway-type microperforated plate may be in a range of 0.1 mm-0.8 mm. For example, the thickness of the runway-type microperforated plate is in a range of 0.2 mm-0.7 mm. As another example, the thickness of the runway-type microperforated plate is in a range of 0.3 mm-0.6 mm.

In some embodiments, the microperforated plate 351 is a circular microperforated plate. When having the same parameters (e.g., a hole diameter, the thickness, a perforation rate, and a cavity (e.g., a cavity 652) height), the circular microperforated plate 351 has a lower intrinsic frequency compared to the runway-type microperforated plate 351. Therefore, the circular microperforated plate needs to be made of a more rigid material and/or have a greater thickness than the runway-type microperforated plate to ensure that the intrinsic frequency is much greater than the maximum frequency of the sound absorbing. In some embodiments, when the microperforated plate 351 is the circular microperforated plate, to make the intrinsic frequency of the microperforated plate 351 at the free state in the range of 500 Hz-3.6 kHz, the Young's modulus of the material of the microperforated plate 351 is in a range of 50 Gpa-200 Gpa. For example, the Young's modulus of the circular microperforated plate material is in a range of 60 Gpa-180 Gpa. As another example, the Young's modulus of the circular microperforated plate material is in a range of 80 Gpa-150 Gpa. As another example, the Young's modulus of the circular microperforated plate material is in a range of 100 Gpa-150 Gpa. In some embodiments, when the microperforated plate 351 is the circular perforated plate, to make the intrinsic frequency of the microperforated plate 351 in the range of 500 Hz-3.6 kHz in the free state, the thickness of the circular microperforated plate is in a range of 0.3 mm-1 mm. For example, the thickness of the circular microperforated plate needs to be in a range of 0.4 mm-0.9 mm. As another example, the thickness of the circular microperforated plate needs to be in a range of 0.5 mm-0.8 mm. As another example, the thickness of the circular microperforated plate needs to be in a range of 0.6 mm-0.7 mm.

Through adjusting the intrinsic frequency of the microperforated plate 351 by setting the Young's modulus and/or the thickness, the intrinsic frequency of the microperforated plate 351 in a fixed state is prevented from falling within the sound absorbing bandwidth (which affects the sound absorbing effect of the microperforated plate 351).

In some embodiments, a side of the microperforated plate 351 facing the diaphragm 320 is disposed with a waterproof and breathable structure, and the waterproof and breathable structure is used for waterproofing and dustproofing. Specifically, as diameters of the through holes of the microperforated plate 351 are relatively small and prone to capillarity, it is difficult to discharge water after the water enters, which affects the sound leakage reduction effect of the sound absorbing structure. There is a need to dispose the waterproof and breathable structure at an interface between the microperforated plate 351 and the second acoustic cavity 340. In some embodiments, the waterproof and breathable structure covers an entire side of the microperforated plate 351 in contact with the second acoustic cavity 340. In some embodiments, the waterproof and breathable structure covers all of the through holes on the microperforated plate 351 such that the through holes are in communication with the second acoustic cavity 340 through the waterproof and breathable structure.

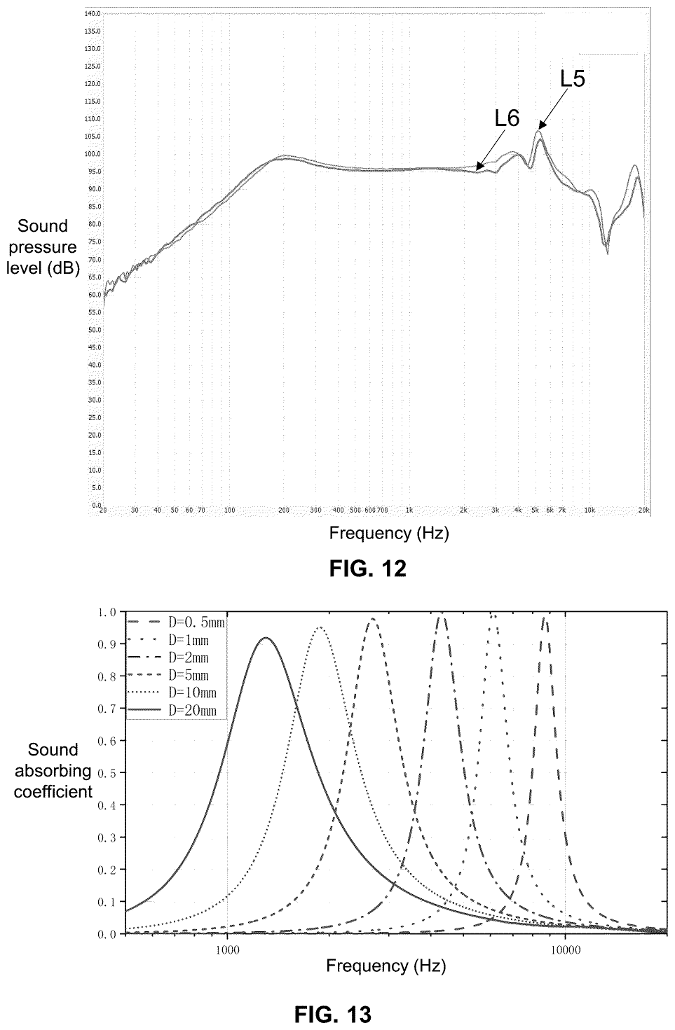

In some embodiments, the waterproof and breathable structure is a gauze. FIG. 12 is a graph illustrating frequency response curves at a second acoustic hole measured with and without a 025HY-type gauze on a side of the microperforated plate facing a diaphragm according to some embodiments of the present disclosure. In FIG. 12, a horizontal axis represents a frequency, a vertical axis represents a sound pressure level, a curve L5 represents a frequency response curve measured at the second acoustic hole 312 (e.g., at a point 10 mm directly in front of the second acoustic hole 312) when the 025HY-type gauze is disposed, and a curve L6 represents a frequency response curve measured at the second acoustic hole 312 (e.g., at the point 10 mm directly in front of the second acoustic hole 312) when the gauze is not disposed. As shown in FIG. 12, the curve L5 is slightly higher than the curve L6, and there is not much difference in the sound pressure level between the two. Thus, a sound absorbing effect of the microperforated plate 351 with the 025HY-type gauze is slightly reduced compared to a sound absorbing effect of the microperforated plate 351 without the gauze, which is not a significant effect, but the change plays a role in waterproofing and dustproofing to a certain extent (e.g., the acoustic device with the 025HY-type gauze may pass a waterproof test of IPX 7). Therefore, in some embodiments, the side of the microperforated plate 351 facing the diaphragm is disposed with the 025HY-type gauze to make the microperforated plate sound absorbing structure waterproof and dustproof. In some embodiments, an acoustic resistance of the 025HY-type gauze is less than 50 MKSRayls. Thus, the side of the microperforated plate 351 facing the diaphragm may be disposed with the gauze, and the acoustic resistance of the gauze may be lower than 50 MKSRayls, so as to be waterproof and dustproof without affecting an output effect of the acoustic device (e.g., the second acoustic hole).

The cavity 352 is disposed on a side of the microperforated plate 351 away from the second acoustic cavity 340, which is connected to the outside world only through the through holes on the microperforated plate 351. In some embodiments, a shape of the cavity body 352 includes, but is not limited to, a cuboid as shown in FIG. 9, regular shapes such as spheres and cylinders or irregular shapes such as a runway shape. In some embodiments, the cavity 352 has a certain height D (referring to FIG. 9), and the greater the height of the cavity D, the wider the sound absorbing bandwidth. In such cases, in some embodiments, the sound absorbing effect of the microperforated plate sound absorbing structure is enhanced by setting a greater height D of the cavity D It is to be understood that the cavity 352, when in a regular shaped, has a height equal to the height D of the cavity. Whereas when the cavity 352 is in an irregular shape, the height is difficult to determine, an equivalent height D of the cavity may be expressed by a ratio of a volume of the cavity 352 to an area of the microperforated plate 351 (i.e., an area of the side of the microperforated plate facing the cavity 352). The volume of the irregular cavity 352 may be measured using a glue injection manner, whereby a special glue is injected into the cavity 352 through acoustic holes on the acoustic output device, and after shaping, the housing is peeled off, and then a volume measurement is performed using a drainage manner of the shaped special glue to obtain the volume of the irregular cavity 352.

FIG. 13 is a graph illustrating sound absorbing coefficients for microperforated plate sound absorbing structures with different height of the cavities according to some embodiments of the present disclosure. As shown in FIG. 13, as the height D of the cavity 352 increases, a peak horizontal coordinate of the corresponding curve gradually shifts to the left, and a peak of the corresponding curve gradually decreases, but a coverage width of the corresponding curve gradually increases. Therefore, the greater the height D of the cavity, the lower a frequency of a corresponding sound absorbing, the smaller a maximum absorbing coefficient, but the wider the absorbing bandwidth.

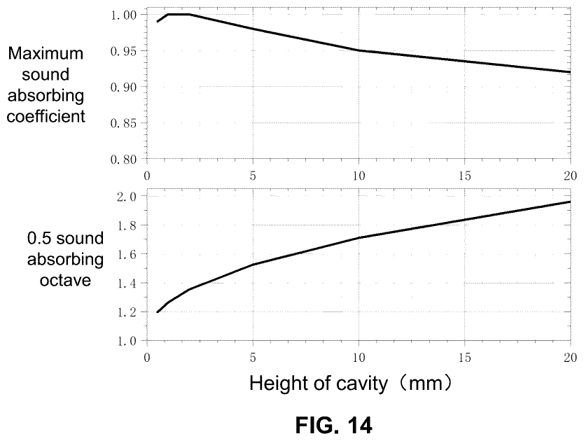

FIG. 14 is a graph illustrating a maximum sound absorbing coefficient and a 0.5 sound absorbing octave of different heights of the cavities according to some embodiments of the present disclosure. The 0.5 sound absorbing octave refers to an octave range that the sound absorbing curve spans when the sound absorbing coefficient is 0.5. The greater the octave range, the wider the sound absorbing bandwidth. As shown in FIG. 14, as the height D of the cavity increases, the corresponding maximum sound absorbing coefficient gradually decreases, but the 0.5 sound absorbing octave gradually increases, that is, the sound absorbing bandwidth gradually becomes wider.

In summary, the greater the height D of the cavity 352, the wider the sound absorbing bandwidth may be obtained near a required resonant sound absorbing frequency. However, the greater the height of the cavity, the smaller the maximum sound absorbing coefficient corresponding to the resonant sound absorbing frequency. Thus, in some embodiments, the height D of the cavity takes a value in a range of 0.5 mm-10 mm to balance the sound absorbing bandwidth and the maximum sound absorbing coefficient of the microperforated plate sound absorbing structure. For example, the value of the height D of the cavity is in a range of 2 mm-9 mm. As another example, the value of the height D of the cavity is in a range of 4 mm-9 mm. As another example, the value of the height D of the cavity is in a range of 7 mm-10 mm.

In some embodiments, a plurality of through holes are spaced apart on the microperforated plate 351. In some embodiments, the plurality of through holes as a whole are distributed in any manner. For example, the plurality of through holes are distributed in an array. For example, the plurality of through holes are distributed in a ring around a center point. In some embodiments, spacings between the through holes (also referred to as a hole spacing) are the same or different. The spacing between the through holes in the present disclosure refers to a minimum distance between an edge of a through hole and an edge of an adjacent through hole.

In some embodiments, the hole spacing between the through holes is much greater than a hole diameter of the through hole (where the hole diameter refers to a diameter of the through hole), and a ratio of the hole spacing to the hole diameter of the through hole is greater than 3. In some embodiments, the hole spacing is much greater than the hole diameter of the through hole, and the ratio of the hole spacing to the hole diameter of the through hole is greater than 5. In some embodiments, the hole spacing is much greater than the hole diameter of the through hole, and the ratio of the hole spacing to the hole diameter of the through hole is greater than 7. In some embodiments, the hole spacing is much greater than the hole diameter of the through hole, and the ratio of the hole spacing to the hole diameter of the through hole is greater than 10. When the hole spacing is greater than the hole diameter, features of the transmitted sound waves between the holes may be mutually unaffected.

In some embodiments, the hole spacing of the through holes on the microperforated plate is much smaller than a wavelength of the sound in a target frequency range. In some embodiments, a ratio of the wavelength of the sound in the target frequency range to the hole spacing is greater than 5. In some embodiments, the ratio of the wavelength of the sound in the target frequency range to the hole spacing is greater than 7. In some embodiments, the ratio of the wavelength of the sound in the target frequency range to the hole spacing is greater than 10. Merely by way of example, the target frequency range is 3 kHz-6 kHz, and the wavelength of the sound in the target frequency range is in a range of 53 mm-110 mm. The ratio of the wavelength of the sound in the target frequency range to the hole spacing is greater than 5, for example, the hole spacing is in a range of 10 mm-22 mm. When the hole spacing is much smaller than the wavelength, a reflection of the sound waves from an inter-hole plate (a region of the microperforated plate 351 between the edge of the through hole and the edge of the adjacent through hole) may be neglected, so that an impact of the reflection from the inter-hole plate on a sound wave propagation process is avoided.

In some embodiments, within an effective hole diameter range, the smaller the hole diameter of the through holes, the greater the acoustic resistance to the sound waves passing through the through holes, the more energy is dissipated, and the wider the sound absorbing bandwidth. Therefore, the sound absorbing effect of the microperforated plate sound absorbing structure may be improved by setting a smaller hole diameter of the through holes. The effective hole diameter range refers to that the sound absorbing bandwidth of the microperforated plate sound absorbing structure with a hole diameter within the range satisfies the requirement of reducing the sound leakage. When the hole diameter is in the effective hole diameter range, the smaller the hole diameter, the better the sound absorbing effect, and when the hole diameter is smaller than the effective hole diameter range, the sound absorbing bandwidth is greatly reduced. In some embodiments, the effective hole diameter range is in a range of 0.1 mm-1 mm. At the same time, considering a machining process requirement, in some embodiments, the effective hole diameter range is in a range of 0.2 mm-0.4 mm. For example, the effective hole diameter range is in a range of 0.2 mm-0.3 mm. In some embodiments, the effective hole diameter range is in a range of 0.1 mm-0.4 mm. For example, the effective hole diameter range is in a range of 0.1 mm-0.2 mm.

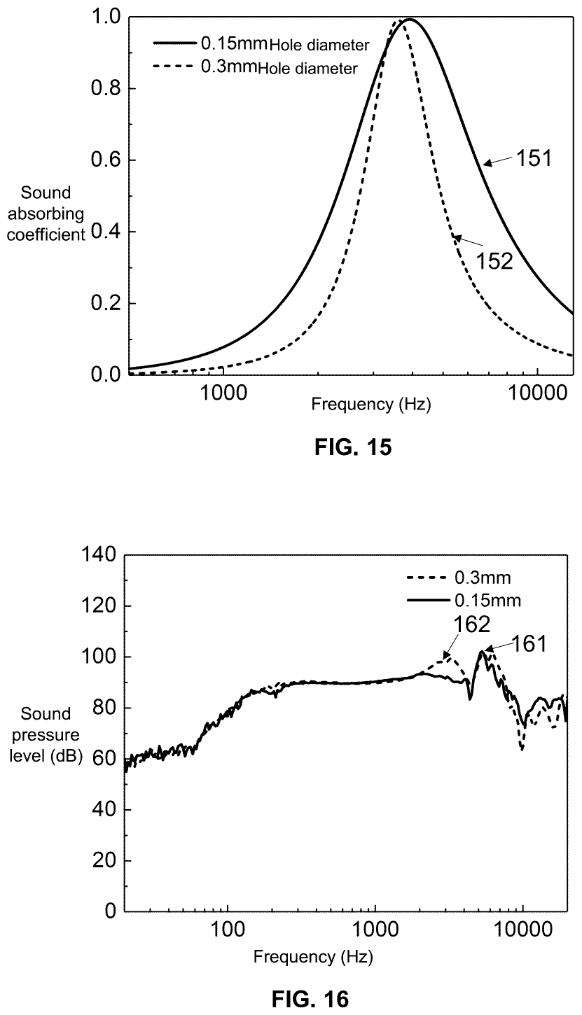

FIG. 15 is a schematic diagram illustrating sound absorbing effects of microperforated plates with hole diameters of 0.15 mm and 0.3 mm respectively according to some embodiments of the present disclosure. A horizontal axis in FIG. 15 represents a sound absorbing frequency, a vertical axis represents a sound absorbing coefficient, a curve 151 represents a sound absorbing effect of the microperforated plate 351 with through holes with a hole diameter of 0.15 mm, and the curve 152 represents the sound absorbing effect of the microperforated plate 351 with through holes with a hole diameter of 0.3 mm. As shown in FIG. 15, a width of curve 151 is greater than a width of the curve 152, but heights of the two are close. It may be seen that a sound absorbing bandwidth and a sound absorbing effect of the microperforated plate 351 with the hole diameter of 0.15 mm is significantly better than a sound absorbing bandwidth and a sound absorbing effect of the microperforated plate 351 with the hole diameter of 0.3 mm.

FIG. 16 is a graph illustrating frequency response curves of microperforated plates 351 with hole diameters of 0.15 mm and 0.3 mm according to some embodiments of the present disclosure. In FIG. 16, a horizontal axis represents a frequency, a vertical axis represents a sound pressure level, a curve 161 represents a frequency response of the microperforated plate 351 with a hole diameter of 0.15 mm, a curve 162 represents a frequency response of the microperforated plate 351 with a hole diameter of 0.3 mm. The frequency response refers to a frequency response of a sound emitted from a second acoustic hole. As shown in FIG. 16, a sound leakage of the curve 161 in a frequency band of 2 kHz-4 kHz is lower than a sound leakage of the curve 162 by about 6 dB. It may be seen that a sound absorbing effect of the microperforated plate 351 with the hole diameter of 0.15 mm is significantly better than the sound absorbing effect of the microperforated plate 351 with the hole diameter of 0.3 mm in a middle and high frequency range. Thus, in some embodiments, the microperforated plate 351 with the hole diameter of 0.15 mm or near 0.15 mm may be adopted for a better sound absorbing. For example, the microperforated plate 351 with a hole diameter in a range of 0.1 mm-0.2 mm is adopted. In some embodiments, considering requirements for dust proof and drainage, the microperforated plate 351 with the hole size of 0.3 mm or near 0.3 mm (e.g., 0.28 mm-0.35 mm) is adopted.

In some embodiments, to avoid to many through holes leading to too small hole spacings, which affects a feature of a transmission of the sound waves between the through holes, a perforation rate of the microperforated plate 351 is less than 5%. The perforation rate refers to a proportional relationship between a total area of the through holes and a side area of the microperforated plate 351 near the second acoustic cavity 340.

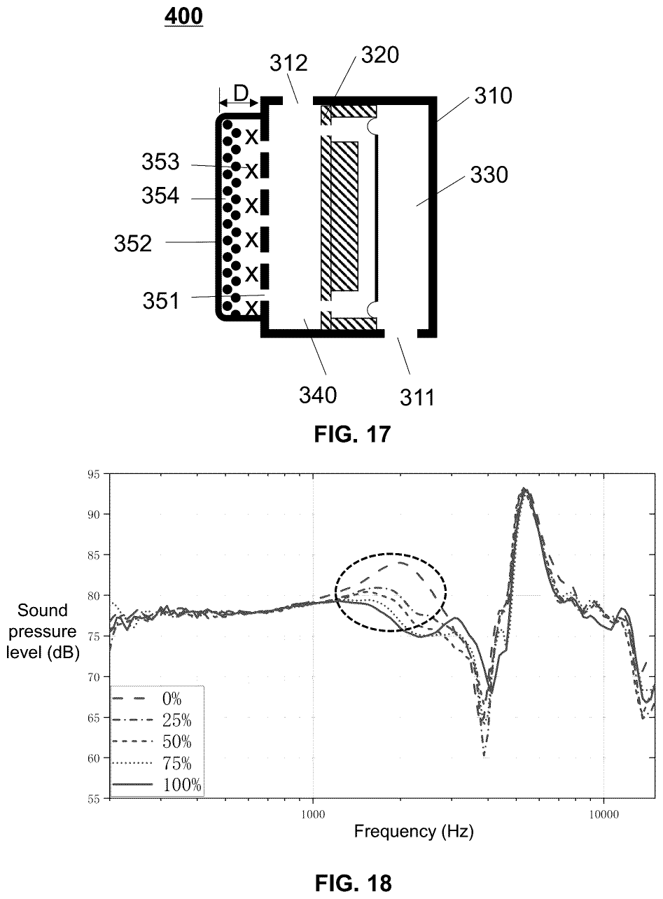

In some embodiments, too small a microporous size increases a difficulty of process, and a deep cavity depth D increases a size of an acoustic device, and thus the sound absorbing effect of the microperforated plate sound absorbing structure is enhanced by a resistive sound absorbing structure. FIG. 17 is a schematic diagram illustrating a structure of an acoustic device with a sound absorbing structure according to some embodiments of the present disclosure. As shown in FIG. 17, a resistive sound absorbing structure may be disposed in the cavity 352 of a microperforated plate sound absorbing structure. In some embodiments, the resistive sound absorbing structure also includes a filling material 354 (e.g., N'Bass particles or a porous acoustic material). The filling material 354 may be used to increase an equivalent height of the cavity 352 of the microperforated plate sound absorbing structure, thereby reducing a designed size of the acoustic device 1300 while enhancing a sound absorbing effect of the microperforated plate sound absorbing structure. Specifically, the filling material 354 has a “sponge” effect. Air molecules are adsorbed and desorbed between the holes of the filling material 354 when the sound waves propagate, which is regarded as a reduction of a sound speed in the filling material 354, and is equivalent to an increase in a volume of the cavity 352, so as to widen a sound absorbing bandwidth of the microperforated plate 351 and increase a sound absorbing coefficient (without affecting a center frequency of the sound absorbing), thereby reducing the designed size of the acoustic device while enhancing the sound absorbing effect of the microperforated plate sound absorbing structure.

In some embodiments, the cavity 352 is filled with N'Bass (silica-aluminate) sound absorbing particles. In some embodiments, the N'Bass sound absorbing particles are filled within the cavity 352 in various manners. Merely by way of example, the N'Bass sound absorbing particles are filled directly within the cavity 352, or the N'Bass sound absorbing particles are filled within a powder packet, which is disposed within the cavity 352, or the N'Bass sound absorbing particles are encapsulated in a specifically shaped gauze, with the gauze disposed within the cavity 352, or the N'Bass sound absorbing particles are filled within the cavity 352 in at least two of the above described filling manners.

In some embodiments, the smaller the N'Bass sound absorbing particles, the smaller the spacing between individual acoustic particles, i.e., the stronger the adsorption effect of the air molecules. Correspondingly, the smaller the particles, the more N'Bass sound absorbing particles need to be filled in, which increases a cost. Therefore, a diameter of the N'Bass sound absorbing particles may be in a range of 0.15 mm-0.7 mm to balance the cost while ensuring the sound absorbing effect. For example, the diameter of the N'Bass sound absorbing particles is in a range of 0.15 mm-0.6 mm. As another example, the diameter of the N'Bass sound absorbing particles is in a range of 0.2 mm-0.6 mm. As another example, the diameter of the N'Bass sound absorbing particles is in a range of 0.3 mm-0.5 mm.

In some embodiments, as a filling rate of the N'Bass sound absorbing particles in the cavity 352 gradually increases, there are more N'Bass sound absorbing particles in the cavity 352, and the sound absorbing effect gradually increases. The filling rate refers to a ratio of a volume of the filled N'Bass sound absorbing particles to a volume of the cavity 352. However, when the N'Bass sound absorbing particles are completely filled with the cavity 352, a pressure on a plate surface of the microperforated plate sound absorbing structure against the N'Bass sound absorbing particles makes the N'Bass sound absorbing particles fragment, thereby clogging gaps between the N'Bass sound absorbing particles, which in turn reduces the sound absorbing effect.

FIG. 18 is a graph illustrating frequency response curves of a second acoustic cavity of an acoustic device corresponding to different filling rates of filling materials according to some embodiments of the present disclosure. As shown in FIG. 18, when the filling rate of the filling material (e.g., N'Bass sound absorbing particles) is 0%, i.e., a cavity of a sound absorbing structure of a microperforated plate is not filled with the filling material, a frequency response curve corresponding to the second acoustic cavity of the acoustic device forms a wave peak near 2 kHz (shown by a dotted circle in FIG. 18), indicating that the second acoustic cavity has a great sound output at 2 kHz. When the filling rate of the filling material is 25%, i.e., 25% of a space in the cavity of the microperforated plate sound absorbing structure is filled with the filling material, a great amount of wave peaks near 2 kHz are absorbed but small wave peaks still exist. When the filling rate is 50%, i.e., 50% of the space in the cavity of the microperforated plate sound absorbing structure is filled with the filling material, the wave peaks near 2 kHz are further absorbed, and the corresponding frequency response curve tends to be flat. When the filling ratio of the filling material is 75%, i.e., 75% of the space of the cavity of the microperforated plate sound absorbing structure is filled with the filling material, the wave peaks near 2 kHz is further absorbed, but another wave peak is formed near 3 kHz. A sound output volume of the second acoustic cavity near 3 kHz slightly increases. When the filling rate of filling material is 100%, i.e., the cavity of the microperforated plate sound absorbing structure is completely filled with filling material, the wave peak near 2 kHz is further absorbed, but a wave peak grows further near 3 kHz, the peak is obvious, and the sound output of the second acoustic cavity is further increased near 3 kHz. To make the response curve of the second acoustic cavity flatter, and to avoid as much as possible peaks in the curve within a preset range (e.g., a range of 2 kHz-3 kHz), in some embodiments, the filling rate of the filling material takes a value in a range of 30%-100%. In some embodiments, the filling rate is in a range of 70%-95%. For example, the filling rate is in a range of 75%-90%. For another example, the filling rate is in a range of 80%-90%. In some embodiments, considering the cost of filling the N'Bass sound absorbing particles, the filling rate is in a range of 75%-85%. For example, the filling rate is 80%.

By setting the filling ratio of the N'Bass sound absorbing particles in the range of 70%-95%, the sound absorbing effect is ensured while avoiding a pressure of the microperforated plate sound absorbing structure on the N'Bass sound absorbing particles to block the gap and thus reduce the sound absorbing effect.

In some embodiments, as a diameter of the N'Bass sound absorbing particles is close to or smaller than the hole diameter of the through hole, to prevent the N'Bass sound absorbing particles from blocking the through hole, as illustrated in FIG. 17, a gauze 353 is disposed between the N'Bass sound absorbing particles and the microperforated plate 351. In some embodiments, the side of the microperforated plate 351 away from the second acoustic cavity 340 (or the diaphragm 320) is covered with the gauze 353, and the gauze 353 covers all of the through holes on the microperforated plate 351. In some embodiments, the gauze 353 is disposed at the cavity 352 between the N'Bass sound absorbing particles and the microperforated plate 351. Specifically, the gauze 353 may be connected to an inner wall of the cavity 352 between the N'Bass sound absorbing particles and the microperforated plate 351.

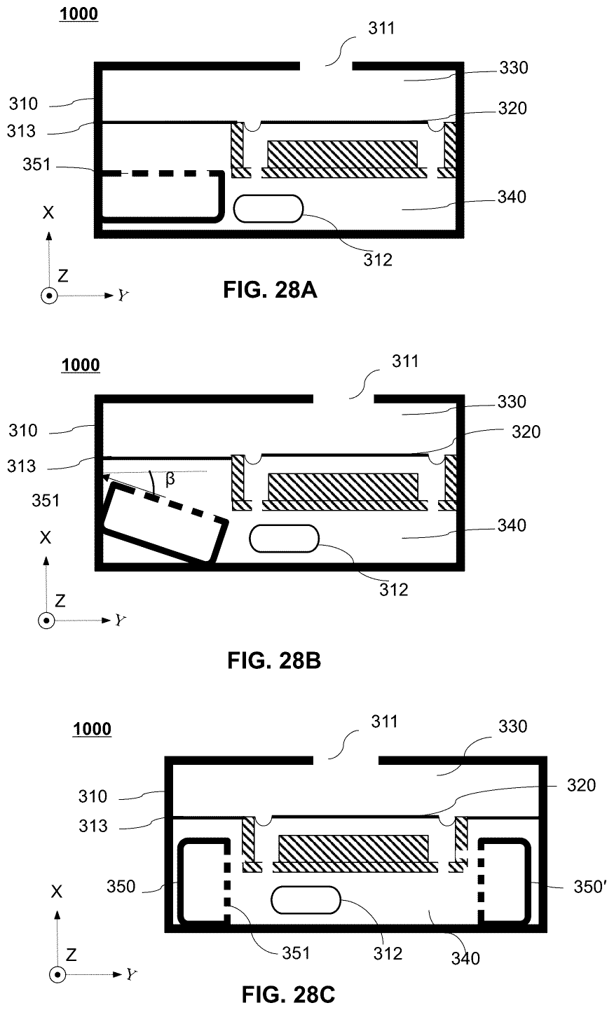

In some embodiments, the microperforated plate sound absorbing structure is disposed facing the second acoustic cavity, e.g., an angle between a normal of the side of the microperforated plate facing the second acoustic cavity and a vibration direction of the diaphragm (e.g., the angle α shown in FIG. 20) is in a range of 0°-90°, so that sound waves of a target frequency in the second acoustic cavity are effectively absorbed. It is important to know that the angle here refers to an absolute value of an angle between the normal and the vibration direction of the diaphragm. For example, for the microperforated plate sound absorbing structures 350 and 350′ as shown in FIG. 28C, the angles between the normals of the sides of the microperforated plates facing the second acoustic cavity 340 and the vibration directions of the diaphragms are both 90°.

In some embodiments, the microperforated plate is disposed parallel or approximately parallel to the diaphragm. For example, the angle between the normal of the side of the microperforated plate facing the second acoustic cavity and the vibration direction of the diaphragm is in a range of 0°-10°, so as to enhance an assembly tolerance between the sound absorbing structure and the housing, avoid a situation where a thickness of the sound generation component of the microperforated plate sound absorbing structure along the vibration direction needs to be increased due to an excessive inclination angle, thereby favoring a reduction in the volume and/or weight of the sound generation component.

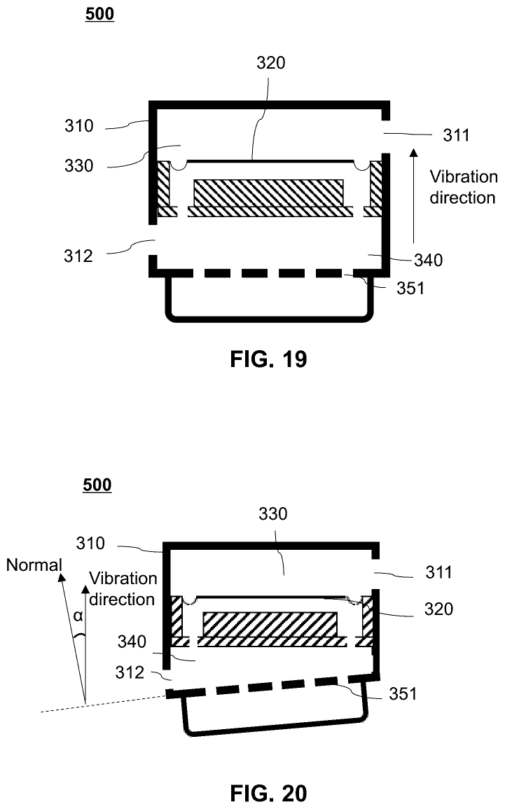

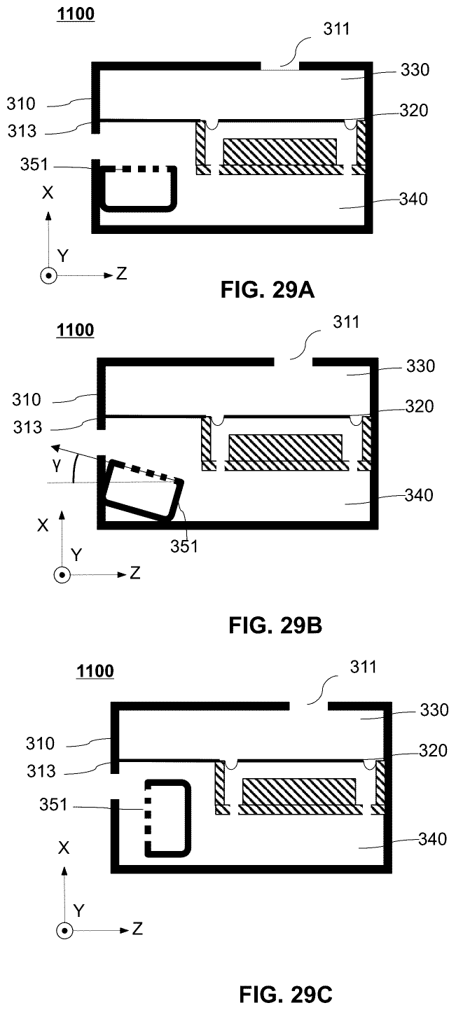

In some embodiments, the microperforated plate is disposed at an inclination relative to the diaphragm, e.g., the angle between the normal of the side of the microperforated plate facing the second acoustic cavity and the vibration direction of the diaphragm is in a range of 10°-90° to adapt to different structural or functional needs. In some embodiments, the angle between the normal of the side of the microperforated plate facing the second acoustic cavity and the vibration direction of the diaphragm is in a range of 10°-45°, where the microperforated plate is inclined relative to the diaphragm, which allows for specific structures or satisfies specific sound absorbing requirements. For example, the microperforated plate is set at a certain inclination relative to the diaphragm, thereby adjusting a distance between the diaphragm and two second acoustic holes, and further adjusting the sound absorbing effect. In some embodiments, the angle between the normal of the side of the microperforated plate facing the second acoustic cavity and the vibration direction of the diaphragm is in a range of 45°-90°. For example, the angle between the normal of the side of the microperforated plate facing the second acoustic cavity and the vibration direction of the diaphragm is 90°, i.e., the microperforated plate is set vertically relative to the diaphragm, and at this time, the microperforated plate sound absorbing structure is set at a corner position of the second acoustic cavity to avoid an increase of a thickness of the sound generation component due to a great inclination angle of the microperforated plate sound absorbing structure. Merely by way of example, referring to FIG. 28B, the microperforated plate is disposed on a side of the diaphragm along a long axis direction of the sound generation component and arranged at an inclined angle relative to the vibration direction of the diaphragm as well as the long axis direction Y of the sound generation component. As another example, with reference to FIG. 29B, the microperforated plate is disposed on a side of the diaphragm along a short axis direction of the sound generation component and arranged inclined relative to the vibration direction of the vibrating diaphragm and the short axis direction Z of the sound generation component. The following will exemplarily illustrate, in combination with FIG. 19-FIG. 29C, embodiments in which the microperforated plate is disposed in parallel or at an inclination relative to the diaphragm.

In some embodiments, the microperforated plate sound absorbing structure 350 is arranged inside the housing of the acoustic device along the vibration direction of the diaphragm 320. For example, the microperforated plate sound absorbing structure 350 is arranged in the vibration direction of the diaphragm 320. An angle between the normal of the side of the microperforated plate in the microperforated plate sound absorbing structure 350 facing the second acoustic cavity (or a plane on which the microperforated plate is located) and the vibration direction is in a range of 0°-10°.

FIG. 19 is a schematic diagram illustrating a structure of an acoustic device disposed with a sound absorbing structure according to some embodiments of the present disclosure. As shown in FIG. 19, an acoustic device 500 includes a microperforated plate 351 disposed in a vibration direction of a diaphragm, and a normal of a side of the microperforated plate 351 facing the second acoustic cavity 340 is substantially parallel to the vibration direction of the diaphragm 320. At this time, the second acoustic hole 312 is disposed on the side of the second acoustic cavity 340 adjacent to the microperforated plate 351.

FIG. 20 is a schematic diagram illustrating a structure of another acoustic device disposed with a sound absorbing structure according to some embodiments of the present disclosure. As shown in FIG. 20, the acoustic device 500 includes a microperforated plate 351 disposed in the vibration direction of the diaphragm, and a normal of a side of the microperforated plate 351 facing the second acoustic cavity 340 is at a certain angle α to the vibration direction of the diaphragm 320, the angle α being greater than 0° and less than 10°. At this time, the second acoustic hole 312 is disposed on a side of the second acoustic cavity 340 adjacent to the microperforated plate 351.

In some embodiments of the present disclosure, by disposing the microperforated plate sound absorbing structure in the vibration direction of the diaphragm, the space of the rear cavity is fully utilized, and the second acoustic hole located on the side of the sound generation component (e.g., on the upper side US or the lower side LS) is made adjacent to the microperforated plate sound absorbing structure. For example, as shown in FIG. 3B, when the second acoustic hole is disposed on the upper side US or the lower side LS of the sound generation component away from an opening of an ear canal, the microperforated plate sound absorbing structure is disposed in the vibration direction of the diaphragm and is connected to the upper side US and the lower side LS, so that the microperforated plate is disposed close to the second acoustic hole, thereby improving an absorbing effect of the microperforated plate sound absorbing structure on the sound at the second acoustic hole. When a plurality of second acoustic holes are disposed on the upper side US or the lower side LS of the sound generation component, by disposing the microperforated plate sound absorbing structure in the vibration direction of the diaphragm, a distance between each of the second acoustic holes and the microperforated plate sound absorbing structure is made shorter, thereby ensuring a comprehensive sound absorbing effect of the microperforated plate sound absorbing structure on all of the second acoustic holes. In addition, the angle between the normal of the side of the microperforated plate facing the second acoustic cavity and the vibration direction of the diaphragm is set in a range of 0°-10°, so as to avoid the a situation where a thickness of the sound generation component of the microperforated plate sound absorbing structure along the vibration direction needs to be increased due to an excessive inclination angle, thereby favoring a reduction in the volume and/or weight of the sound generation component.

In some embodiments, for the acoustic device adopting a wearing manner as shown in FIG. 3A (i.e., the sound generation component is partially extended into a concha cavity), when the microperforated plate sound absorbing structure is disposed in the vibration direction of the diaphragm, the microperforated plate sound absorbing structure is specifically disposed at an end that is away from the end FE along the long axis direction of the sound generation component. In this way, the thickness of the end FE of the sound generation component along the vibration direction may not be increased, thereby avoiding the end FE of the sound generation component from being unable to penetrate deep into the concha cavity due to the excessive thickness. In some embodiments, for the acoustic device adopting the wearing manner as shown in FIG. 5 (i.e., the sound generation component partially covers a region of an antihelix), when the microperforated plate sound absorbing structure is disposed in the vibration direction of the diaphragm, the microperforated plate sound absorbing structure is specifically disposed at any position along a length direction or a width direction of the sound generation component without interfering with the wearing of the acoustic device.

In some embodiments, the angle between the normal of the side of the microperforated plate facing the second acoustic cavity and the vibration direction is in the range of 0°-10°, and the microperforated plate sound absorbing structure is not arranged in the vibration direction of the diaphragm. For example, as shown in FIG. 28A, the angle between the normal of the side of the microperforated plate facing the second acoustic cavity and the vibration direction is approximated to be 0°, and the microperforated plate sound absorbing structure is arranged in the sound generation component on a side of the diaphragm along the long axis direction Y. As another example, as shown in FIG. 29A, the angle between the normal of the side of the microperforated plate facing the second acoustic cavity and the vibration direction is approximated to be 0°, and the microperforated plate sound absorbing structure is disposed on a side of the diaphragm along the short axis direction Z of the sound generation component. Specific contents on the microperforated plate sound absorbing structure arranged on a side of the diaphragm along the long axis and/or short axis direction may be found in FIGS. 28A-29C and the related descriptions.

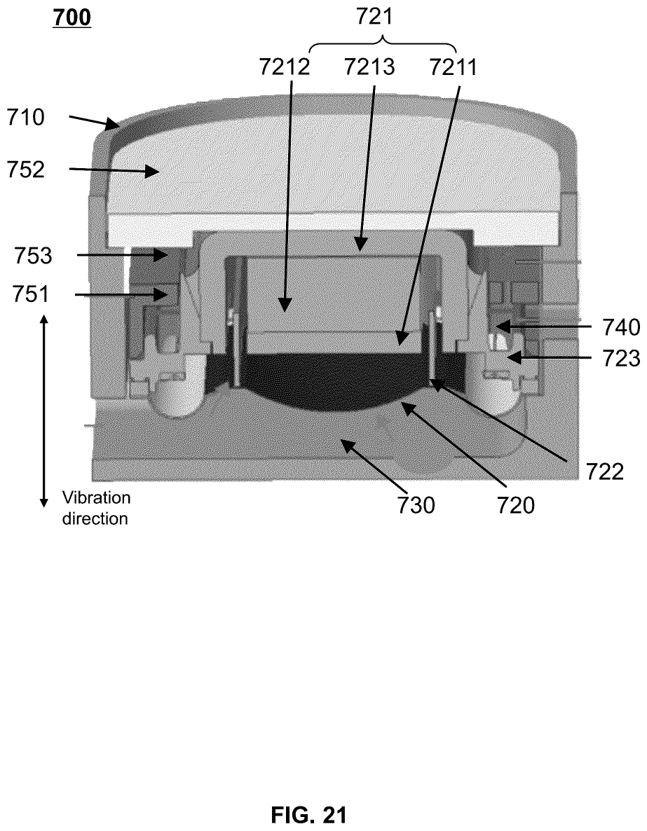

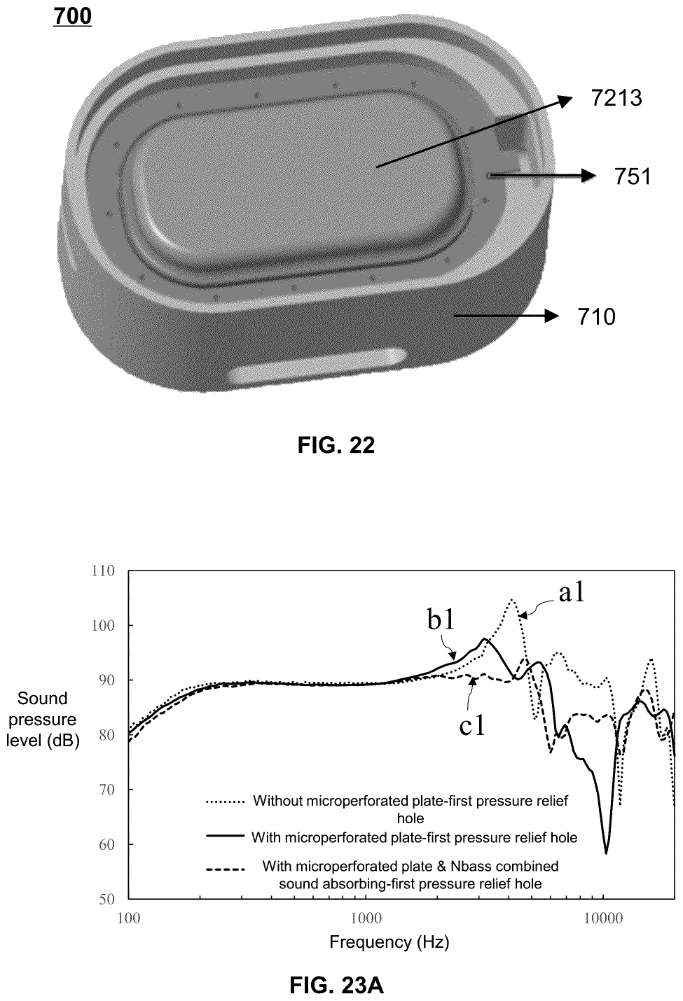

FIG. 21 is a schematic diagram illustrating an internal structure of an acoustic device according to some embodiments of the present disclosure. FIG. 22 is a schematic diagram illustrating an internal structure of an acoustic device according to some embodiments of the present disclosure.

As shown in FIG. 21 and FIG. 22, a diaphragm 720 of an acoustic device 700 separates an accommodation cavity of a housing 710 into a first acoustic cavity 730 and a second acoustic cavity 740, and the acoustic device further includes a coil 722, a frame 723, and a magnetic circuit assembly 721. The frame 723 is disposed around the diaphragm 720, the coil 722, and the magnetic circuit assembly 721 for providing a mounting and fixing platform, and the diaphragm 720 is connected to the housing 710 through the frame 723. The diaphragm 720 covers the coil 722 and the magnetic circuit assembly 721 in a vibration direction. At least a portion of the coil 722 extends into a magnetic gap formed by the magnetic circuit assembly 721 and is connected to the diaphragm 720. After the coil 722 is powered, a magnetic field generated by the coil 722 has an interaction with a magnetic field formed by the magnetic circuit assembly 721 to drive the diaphragm 720 to generate a mechanical vibration, thereby generating a sound through air and other media. The sound is then output through a hole on the housing 710. A microperforated plate sound absorbing structure may be disposed within the second acoustic cavity 740. For example, the microperforated plate sound absorbing structure is disposed around the magnetic circuit assembly 721. The microperforated plate sound absorbing structure includes a microperforated plate 751 and a filling layer 753. A side of the microperforated plate 751 away from the diaphragm 720 along a vibration direction is articulated with the filling layer 753. The microperforated plate 751 is a ring structure disposed around the magnetic circuit assembly 721. The filling layer 753 is filled with N'Bass sound absorbing particles or a porous acoustic material. In some embodiments, the housing 710 (e.g., a back plate 752) encloses a closed cavity, i.e., a cavity of the microperforated plate sound absorbing structure. The filling layer 753 is filled in the cavity.

In some embodiments, the magnetic circuit assembly 721 includes a magnetic conduction plate 7211, a magnet 7212, and a magnetic conduction cover 7213. The magnetic conduction plate 7211 and the magnet 7212 are connected. A side of the magnet 7212 away from the magnetic conduction plate 7211 is mounted on a bottom wall of the magnetic conduction cover 7213, and a magnetic gap is formed between a peripheral side of the magnet 7212 and a peripheral inner sidewall of the magnetic conduction cover 7213. In some embodiments, a peripheral outer wall of the magnetic conduction cover 7213 is connected and fixed to the frame 723. In some embodiments, both the magnetically conduction cover 7213 and the magnetic conduction plate 7211 are made of a magnetically conductive material (e.g., iron, etc.).

In some embodiments, a plurality of through holes are disposed on the microperforated plate 751, and the plurality of through holes are disposed around the magnet assembly, which is conducive to ensuring proper hole spacing and perforation rate. In some embodiments, as the microperforated plate 751 needs to be disposed with a sealed cavity with a certain height on the side of the microperforated plate 751 away from the diaphragm, if the microperforated plate 751 is disposed wholly on the side of the magnet assembly away from the diaphragm, the microperforated plate 751 and the filling layer 753 occupy too much space in the housing 710, making it difficult to satisfy a design requirement of a small size of the acoustic device. In the acoustic device 700 of the embodiment, by disposing the microperforated plate 751 as a ring structure surrounding the magnetic circuit assembly, the space in a circumferential direction of the magnetic circuit assembly is effectively utilized without increasing the thickness (i.e., a size along the vibration direction) of the acoustic device, which is conducive to a miniaturization of the design of the acoustic device.

As may be seen from the foregoing, the height D of the cavity, a thickness of the microperforated plate 751, a hole diameter of the through hole, and the perforation rate all have an effect on a sound absorbing bandwidth and a sound absorbing coefficient of the microperforated plate 751, and a combined value of the parameters may be found in the following description.

In general, a sound resistance of a single through hole on the microperforated plate 751 is:

$$Z = \frac{32 ρ μ t}{{d}^{2}} \sqrt{1 + \frac{{x}^{2}}{32}} + j ωρ t ( 1 + \frac{1}{\sqrt{9 + \frac{{x}^{2}}{2}}} ) . \qquad ( 1 )$$

In equation (1), ρ denotes an air density, μ denotes an air motion viscosity coefficient, t denotes the thickness of the microperforated plate 751, and d denotes the hole diameter. When the thickness of the microperforated plate 751 is comparable to the hole diameter, an end correction of the through hole needs to be considered, i.e., an effective thickness is increased by 0.85d. There are a plurality of through holes disposed on the microperforated plate 751, and the sound impedance of the plurality of through holes is equated to a parallelism of the sound impedances of the plurality of through holes, i.e., the sound impedance rate of the microperforated plate 751 is obtained by dividing the sound impedance rate of the individual through hole by the perforation rate:

$${Z}_{M P P} = \frac{32 ρμ t}{σ {d}^{2}} ( \sqrt{1 + \frac{{x}^{2}}{32}} + \frac{k \sqrt{2}}{8} \frac{d}{t} ) + j ωρ t ( 1 + \frac{1}{\sqrt{9 + \frac{{x}^{2}}{2}}} + 0.85 \frac{d}{t} ) . \qquad ( 2 )$$

In equation (2), σ denotes the perforation rate, k denotes a wave count, and the expression is k=ω/c, where ω denotes an angular frequency and c denotes a sound speed. The cavity 652 of the microperforated plate sound absorbing structure is equivalent to an acoustic capacitance, whose sound impedance is:

$${Z}_{D} = - j ρ c \cdot cot ( \frac{ω D}{c} ) . \qquad ( 3 )$$

In equation (3), D denotes the height of the cavity. Then the sound impedance of the microperforated plate sound absorbing structure may be expressed as:

$${Z}_{t o t a l} = {Z}_{M P P} + {Z}_{D} . \qquad ( 4 )$$

After normalization:

$$\frac{{Z}_{total}}{ρ c} = r + j ω m - j ρ c \cdot cot ( \frac{ω D}{c} ) . \qquad ( 5 )$$

In equation (5), r denotes a relative acoustic impedance rate and m denotes a relative sound mass, specifically:

$$r = \frac{32 μ t}{σ c {d}^{2}} ( \sqrt{1 + \frac{{k}^{2}}{32}} + \frac{k \sqrt{2}}{8} \frac{d}{t} ) , \qquad ( 6 )$$

$$m = \frac{t}{σ c} ( 1 + \frac{1}{\sqrt{9 + \frac{{k}^{2}}{2}}} + 0.85 \frac{d}{t} ) . \qquad ( 7 )$$

When the sound wave is incident vertically, the sound absorbing coefficient α of the microperforated plate sound absorbing structure may be:

$$α = 1 - {( \frac{{Z}_{t otal - 1}}{{Z}_{total} + 1} )}^{2} . \qquad ( 8 )$$

A resonant frequency of the sound absorbing structure 350 is:

$$2 π {f}_{0} m - cot ( 2 π {f}_{0} \frac{D}{c} ) = 0 . \qquad ( 9 )$$

According to Eq. (1)-Eq. (9), a sound bandwidth and a sound absorbing coefficient of the sound absorbing structure 350 are controlled by adjusting the hole diameter, the perforation rate, the thickness of the microperforated plate 751, and the height of the cavity.

Alternatively, values of parameters such as the hole diameter, the perforation rate, the thickness, and the height of the cavity may be combined with considerations of the sound absorbing coefficient, a sound absorbing frequency range, and a structural dimension to determine a parameter combination. For example, the sound absorbing bandwidth and a maximum sound absorbing coefficient of the sound absorbing structure constrain each other, which are balanced according to actual needs. For example, the smaller the hole diameter of the microperforated plate, the wider the sound absorbing bandwidth, and the wider sound absorbing bandwidth corresponds to an effective hole diameter range. When the hole diameter is in the effective hole diameter range, the smaller the hole diameter, the better the sound absorbing effect, and when the hole diameter is smaller than the effective hole diameter range, the sound absorbing bandwidth will be greatly reduced. For example, a small hole diameter, a great perforation rate, a small thickness, and a small height of cavity are suitable for a high frequency sound absorbing range, and a great hole diameter, a small perforation rate, a great thickness, and a great height of cavity are suitable for a low frequency sound absorbing range.

In some embodiments, the parameter combination of the microperforated plate 751 is determined based on a resonance frequency of the second acoustic cavity 740, so that the sound absorbing structure is capable of absorbing the sound waves near the resonance frequency of the second acoustic cavity 740 to avoid a change of a phase and/or an amplitude of second sound waves caused by a resonance of the second acoustic cavity 740 near the resonance frequency, thereby reducing the amplitude of the sound waves near the resonance frequency, and ensuring a sound leakage reduction effect. In some embodiments, the parameter combination of the microperforated plate 751 is set such that a target frequency range for sound absorbing includes the resonant frequency, thereby absorbing sound near the resonant frequency. In some embodiments, the second acoustic cavity 740 resonates near 4 kHz, and a human ear is more sensitive to sound near that frequency, and thus the parameter range is set such that the target frequency range of the sound absorbing structure range includes 4 kHz for more targeted and effective sound leakage reduction.

In some embodiments, the microperforated plate 751 has a hole diameter in a range of 0.2 mm-0.4 mm, a perforation rate in a range of 1%-5%, a thickness in a range of 0.2 mm-0.7 mm, and a height of the cavity in a range of 4 mm-9 mm. In some embodiments, the microperforated plate 751 has a hole diameter in a range of 0.25 mm-0.35 mm, a perforation rate in a range of 1.2%-4.5%, a thickness in a range of 0.3 mm-0.6 mm, and a height of the cavity in a range of 5 mm-8 mm. Merely by way of example, the microperforated plate 751 has a hole diameter of 0.25 mm, a perforation rate of 2.8%, a thickness of 0.4 mm, and a height of the cavity of 6 mm. As another example, the microperforated plate 751 has a hole diameter of 0.3 mm, a perforation rate of 3.2%, a thickness of 0.5 mm, and a height of the cavity of 6.5 mm. As another example, the microperforated plate 751 has a hole diameter of 0.35 mm, a perforation rate of 3.6%, a thickness of 0.55 mm, and a height of the cavity of 7 mm.

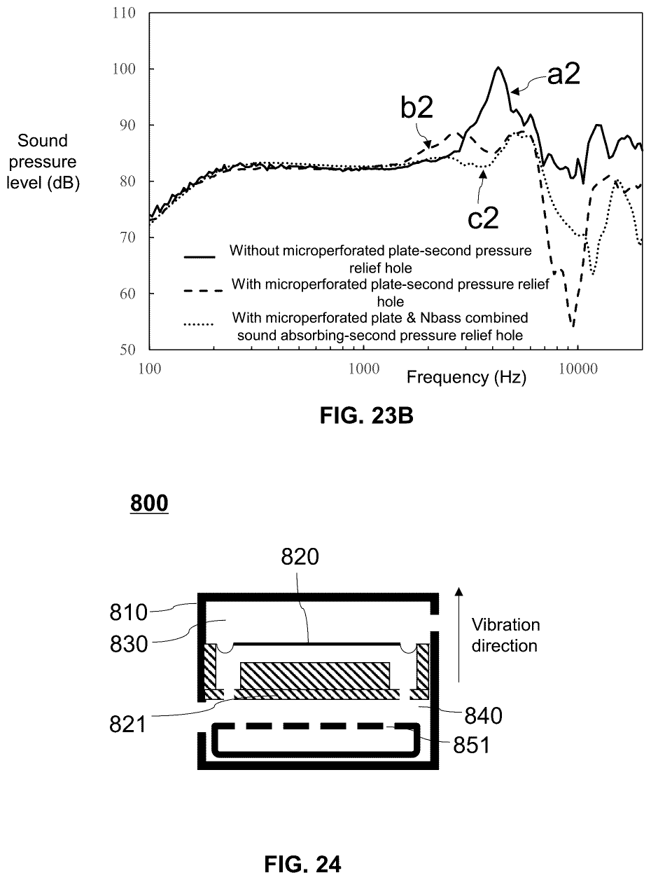

FIG. 23A is a graph illustrating frequency response curves at a second acoustic hole of the acoustic device. FIG. 23B is a graph illustrating frequency response curves at the other second acoustic hole of the acoustic device. In FIG. 23A and FIG. 23B, a horizontal axis represents a frequency and a vertical axis represents a sound pressure level. Curve a1 represents the frequency response of the acoustic device 200 (without a microperforated plate sound absorbing structure) at the second acoustic hole, curve a2 represents the frequency response of the acoustic device 200 at the other second acoustic hole, curve b1 represents the frequency response of the acoustic device 300 (with the microperforated plate sound absorbing structure) at the second acoustic hole, curve b2 represents the frequency response of the acoustic device 300 at the other second acoustic hole, curve c1 represents the frequency response of the acoustic device 400 (with the microperforated plate sound absorbing structure and N'Bass sound absorbing particles) at the second acoustic hole, and curve c2 represents the frequency response of the acoustic device 400 at the other second acoustic hole. The second acoustic hole and the other second acoustic hole are acoustic holes at different positions on the housing corresponding to the second acoustic cavity. The curves b1, b2, c1, and c2 are obtained when the microperforated plate has above parameter combination. The above parameter combination refers to a microperforated plate with a hole diameter in a range of 0.2 mm-0.4 mm, a perforation rate in a range of 1%-5%, a thickness in a range of 0.2 mm-0.7 mm, and a height of the cavity in a range of 4 mm-9 mm. Specifically, the microperforated plate has a pore diameter of 0.3 mm, a perforation rate of 2.8%, a thickness of 0.6, and a height of the cavity of 6 mm.

As shown in FIG. 23A and FIG. 23B, the curve a1 and the curve a2 have a high resonance peak near 4 kHz, and 3.8 kHz corresponds to a resonance frequency of the second acoustic cavity. After providing the microperforated plate sound absorbing structure (the curves b1 and b2), a sound pressure level in a frequency band of 3 kHz-6 KHz is effectively reduced by 4 dB-20 dB and reaches a low point near 4 kHz. It may be seen that the microperforated plate sound absorbing structure is able to effectively absorb sound waves in the range of 3 kHz-6 kHz, and the microperforated plate sound absorbing structure is able to absorb the sound waves near 4 kHz by about 20 dB, which reduces or avoids a resonance of the sound waves near the resonance frequency under an action of the second acoustic cavity, so as to reduce a sound leakage at the resonance frequency. After the cavity of the microperforated plate sound absorbing structure is filled with the N'Bass sound absorbing particles (the curves c1 and c2), a sound absorbing bandwidth is increased, and both the combined sound absorbing solutions have a better sound absorbing effect. Thereby, by setting the hole diameter of the microperforated plate in the range of 0.2 mm-0.4 mm, the perforation rate in the range of 1%-5%, the thickness in the range of 0.2 mm-0.7 mm, and the height of the cavity in the range of 4 mm-9 mm, sound waves around 4 kHz are effectively absorbed, thus reducing the sound leakage of the acoustic device around 4 KHz.

FIG. 24 is a schematic diagram illustrating an internal structure of an acoustic device according to some embodiments of the present disclosure.

As shown in FIG. 24, an acoustic device 800 includes a diaphragm 820, a magnetic circuit assembly 821, a coil (not shown in the figure), and a frame (not shown in the figure). The diaphragm 820 separates an accommodation cavity of the housing 810 into a first acoustic cavity 830 and a second acoustic cavity 840. The diaphragm 820 cooperates with the magnetic circuit assembly 821, the coil, and the frame in a manner similar to that in the acoustic device 700. A microperforated plate sound absorbing structure is coupled to the second acoustic cavity 840. A microperforated plate 851 is disposed on a side of the magnetic circuit assembly 821 away from the diaphragm 820, and the microperforated plate 851 is spaced apart from the magnetic circuit assembly 821 in a vibration direction. In some embodiments, the microperforated plate is a panel (e.g., elliptical, circular, etc.) that is shape-adapted to the second acoustic cavity 840 or the housing 810. In some embodiments, parameters such as a hole diameter, a perforation rate, a hole spacing, etc. of the microperforated plate 851 are consistent with related parameters of the microperforated plate described above (e.g., the microperforated plate of an annular structure disposed around the magnetic circuit assembly). In this way, the microperforated plate with the panel structure has a greater area, a relatively greater count of through holes, a better sound absorbing effect, and a simple structure that is easy to assemble. In some embodiments, the parameters of the microperforated plate 851 are inconsistent with those of the annular structured microperforated plate described above. For example, when a sound absorbing frequency band is similar, the perforation rate of the microperforated plate 851 spaced apart from the magnetic circuit assembly is less than the perforation rate of the annular structured microperforated plate described above. As the area of the microperforated plate 851 is relatively great, a good sound absorbing effect may still be ensured. As another example, when a sound absorbing frequency band is similar, the perforation rate of the microperforated plate 851 spaced apart from the magnetic circuit assembly is greater than the perforation rate of the above-described annular structure. At this time, as the area of the microperforated plate 851 is relatively great, a good sound absorbing effect may still be ensured.

In some embodiments of the present disclosure, by spacing the microperforated plate and the magnetic circuit assembly in the vibration direction of the diaphragm, the sound absorbing effect of the microperforated plate sound absorbing structure is improved with a simple structure, which is easy to assemble. Additionally, by setting the microperforated plate and the magnetic circuit assembly spaced apart in the vibration direction of the diaphragm, the hole diameter, the perforation rate, and other parameters may be more flexibly designed to simplify a manufacturing process while ensuring the sound absorbing effect.

In some embodiments, for the acoustic device that is worn as shown in FIG. 5 (i.e., the sound generation component partially covers an antihelix region), the perforated plate and the magnetic circuit assembly are spaced apart in the vibration direction of the diaphragm so as to improve the sound absorbing effect of the microperforated plate sound absorbing structure, and to allow for a more flexible design of the hole diameter, the perforation rate, and other parameters without affecting the wearing of the acoustic device.

In some embodiments, the parameter combination of the microperforated plate 851 is determined based on a resonance frequency of the second acoustic cavity 840, such that the sound absorbing structure is capable of absorbing sound waves near a resonance frequency of the second acoustic cavity 840 to avoid a change in a phase and/or an amplitude of the second sound wave caused by a resonance of the second acoustic cavity 840 near that resonance frequency, thereby reducing the amplitude of the sound waves near the resonance frequency, and reducing the sound leakage. In some embodiments, the parameter combination of the microperforated plate 851 is set such that the target frequency range for sound absorbing includes the resonance frequency, thereby absorbing sound near that resonance frequency. In some embodiments, the second acoustic cavity 840 resonates near 4 kHz, and a human ear is more sensitive to the sound near that frequency, thus the parameter range is set such that the target frequency range of the sound absorbing structure includes 4 kHz for more targeted and effective sound leakage reduction.

In some embodiments, the microperforated plate 851 has a hole diameter in a range of 0.1 mm-0.2 mm, a perforation rate in a range of 2%-5%, a thickness in a range of 0.2 mm-0.7 mm, and a height of the cavity in a range of 7 mm-10 mm. For example, the hole diameter of the microperforated plate 851 is in a range of 0.1 mm-0.2 mm, the perforation rate is in a range of 2.18%-4.91%, the thickness is in a range of 0.3 mm-0.6 mm, and the height of the cavity is in a range of 7.5 mm-9.5 mm. For example, the microperforated plate 851 has a hole diameter of 0.15 mm, a perforation rate of 2.18%, a thickness of 0.3 mm, and a height of the cavity of 8 mm. As another example, the microperforated plate 851 has a hole diameter of 0.15 mm, a perforation rate of 2.76%, a thickness of 0.4 mm, and a height of the cavity of 8.5 mm. As another example, the microperforated plate 851 has a hole diameter of 0.15 mm, a perforation rate of 3.61%, a thickness of 0.5 mm, and a height of the cavity of 9 mm.

In some embodiments of the present disclosure, by setting the parameter combination of the microperforated plate to have a hole diameter in the range of 0.1 mm-0.2 mm, the perforation rate in the range of 2%-5%, the thickness in the range of 0.2 mm-0.7 mm, the height of the cavity in the range of 7 mm-10 mm range, the target frequency range of the microperforated plate sound absorbing structure includes 4 kHz, and an optimal sound absorbing effect is achieved near 4 kHz, so that the resonance of the sound waves occurring near the resonance frequency under the action of the second acoustic cavity is reduced or avoided, thereby reducing the sound leakage at the resonance frequency.

In some embodiments, the second acoustic cavity (e.g., the second acoustic cavity 740 shown in FIG. 21, the second acoustic cavity 840 shown in FIG. 24, etc.) resonates near 2 kHz-3 kHz and the human ear is more sensitive to the sounds near that frequency, so a parameter range is set such that the target frequency range of the sound absorbing structure includes 2 kHz-3 kHz for more targeted and effective sound leakage reduction.

In some embodiments, the microperforated plate (e.g., the microperforated plate 751, the microperforated plate 851, etc.) has the hole diameter in a range of 0.1 mm-0.3 mm, the perforation rate in a range of 0.5%-5%, the thickness in a range of 0.2 mm-0.6 mm, and the height of the cavity in a range of 4 mm-10 mm. Merely by way of example, the microperforated plate has the hole diameter in the range of 0.3 mm-0.3 mm, the perforation rate in the range of 0.7%-2.3%, the thickness in the range of 0.25 mm-0.55 mm, and the height of the cavity in the range of 4 mm-7.5 mm range. For example, to make a sound absorbing center frequency of the microperforated plate sound absorbing structure near 3 kHz, the hole diameter of the microperforated plate is 0.2 mm, the perforation rate is 0.87%, the thickness of the plate is 0.3 mm, and the height of the cavity is 4.5 mm. As another example, to make the sound absorbing center frequency of the microperforated plate sound absorbing structure near 3 kHz, the hole diameter of the microperforated plate is 0.25 mm, the perforation rate is 1%, the thickness is 0.4 mm, and the height of the cavity is 4.5 mm. As another example, to make the sound absorbing center frequency of the microperforated plate sound absorbing structure near 3 kHz, the hole diameter of the microperforated plate is 0.3 mm, the perforation rate is 0.97%, the thickness is 0.4 mm, and the height of the cavity is 4.5 mm.

In some embodiments of the present disclosure, by making the parameter combination of the microperforated plate have the hole diameter in the range of 0.1 mm-0.3 mm, the perforation rate in the range of 0.5%-5%, the thickness in the range of 0.2 mm-0.6 mm, and the height of the cavity in the 4 mm-10 mm range, the target frequency range of the microperforated plate sound absorbing structure includes 2 kHz-3 kHz, and the optimal sound absorbing effect near 2 kHz-3 KHz can be achieved, so that a more targeted and effective sound leakage reduction is realized.

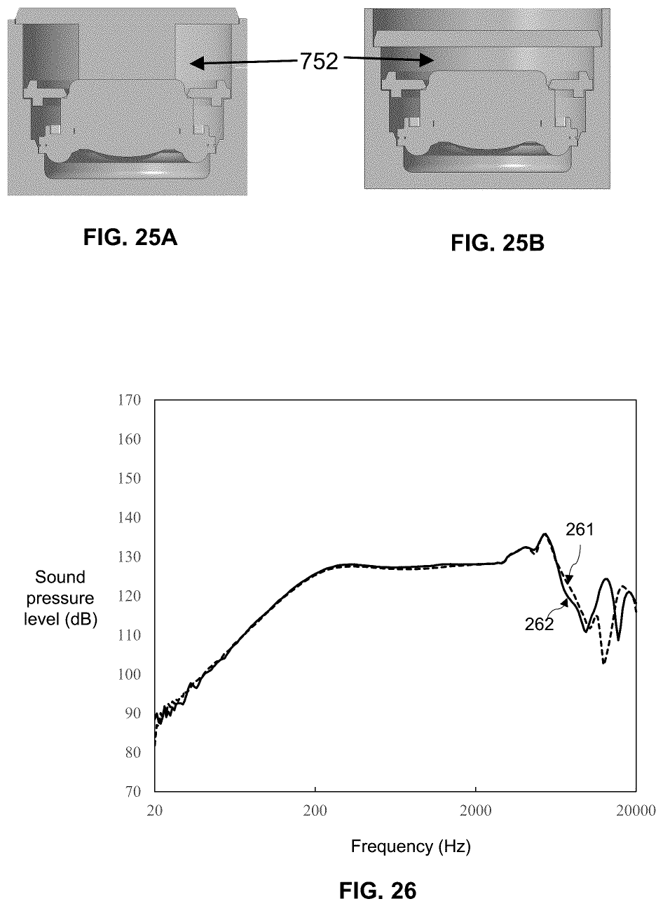

In some embodiments, the cavity of the microperforated plate sound absorbing structure is a regular body shape including a sphere, a cylinder, a runway shape, etc. or an irregular body shape. For example, the cavity is in a shape of a ring disposed around the magnetic circuit assembly as shown in FIG. 25A. As another example, the cavity is in a shape of a flat plate as shown in FIG. 25B. In some embodiments, the heights of the cavities and cross-sectional areas perpendicular to the heights of the cavities as shown in FIG. 25A and FIG. 25B are different, but volumes of the cavities are the same. On this basis, combining FIG. 26, effects of the volume and the height of the cavity on the sound absorbing effect of the sound absorbing structure is determined.

FIG. 26 is a graph illustrating frequency response curves at a second acoustic hole of an acoustic device shown in FIGS. 25A and 25B. In FIG. 26, a horizontal axis represents a frequency and a vertical axis represents a sound pressure level. A curve 261 represents a frequency response of the acoustic device shown in FIG. 25A at the second acoustic hole, and a curve 262 represents the frequency response of the acoustic device shown in FIG. 25B at the same second acoustic hole. The curve 261 is obtained when the microperforated plate has a parameter combination of a hole diameter of 0.3 mm, a perforation rate of 2.1%, a thickness of 0.6 mm, and a height of the cavity of 4 mm, and the curve 262 is obtained when the microperforated plate has a parameter combination of a hole diameter of 0.3 mm, a perforation rate of 2.1%, a thickness of 0.6 mm, and a height of the cavity of 2 mm. The cavities of the acoustic devices shown in FIGS. 25A and 25B are filled with the same volume of N'Bass sound absorbing particles, and the two curves correspond to the same volume of the cavity. According to FIG. 26, curve 261 substantially coincides with curve 262. It may be seen that when the volume of the cavity of the sound absorbing structure is constant, an adjustment of the height and shape of the cavity has a negligible effect on the sound absorbing effect of the sound absorbing structure. Therefore, in some embodiments, the height and shape of the cavity are adjusted when the volume of the cavity of the sound absorbing structure is constant to adapt to functionality and structural requirements of the acoustic device. For example, when the volume of the cavity of the sound absorbing structure is constant, the height of the cavity of the sound absorbing structure is reduced to reduce a size of the acoustic device and realize a miniaturized design.

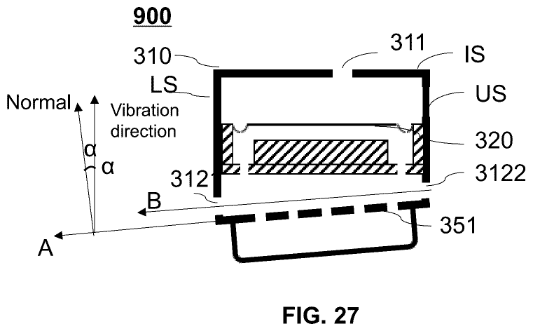

FIG. 27 is a schematic diagram illustrating a structure of an acoustic device according to some embodiments of the present disclosure.

As shown in FIG. 27, in some embodiments, an arrangement direction A of the microperforated plate 351 is at an inclination to a vibration direction, i.e., a normal of a side of the microperforated plate 351 facing the second acoustic cavity is at an angle α. For example, 10°<α<90°. In some embodiments, combining FIG. 27, an acoustic device 900 has two second acoustic holes (i.e., second acoustic holes 3121 and 3122), and the two second acoustic holes are disposed on opposite sides of the housing 310, e.g., disposed opposite to each other in a direction perpendicular to the vibration direction, so as to damage a high pressure region of the acoustic field in the second acoustic cavity to the greatest extent. Taking the acoustic device 10 shown in FIG. 3A as an example, the sound generation component is partially extended into a concha cavity in a wearing state, and combining FIG. 27, the first acoustic hole 311 is on the inner side IS facing the ear canal, and the second acoustic hole 3121 is on the upper side US, and the second acoustic hole 3122 is on the lower side LS. In some embodiments, in the vibration direction (i.e., the thickness direction X shown in FIG. 3A), a distance between the second acoustic hole 3121 and the inner side IS is different from a distance between the second acoustic hole 3122 and the inner side IS. In such cases, the microperforated plate 351 may be inclined so that the distances between the microperforated plate 351 (e.g., a connection between the microperforated plate 351 and the housing 310) and the two second acoustic holes are the same or almost the same, so that the microperforated plate 351 has substantially the same sound absorbing effect on the two second acoustic holes. Specifically, a direction B of a line connecting hole centers of the two second acoustic holes is substantially parallel to the arrangement direction A of the microperforated plate, or a difference between a shortest distance from a centroid of the second acoustic hole 3121 to the microperforated plate 351 and a shortest distance from a centroid of the second acoustic hole 312 to the microperforated plate 351 is in a preset range, e.g., no more than 1/10 of a size of the sound generation component in the vibration direction.

In some embodiments, the distance between the second acoustic hole 3121 and the inner side IS is the same as the distance between the second acoustic hole 3122 and the inner side IS. In the wearing state, when the sound generation component of the acoustic device partially extends into the concha cavity or covers a region of an antihelix (e.g., as shown in FIG. 3A or FIG. 5), the second acoustic hole 3122 disposed on the lower side LS may be closer to an opening of an ear canal. To avoid the sound emitted by the second acoustic hole 3122 from canceling the sound emitted by the first acoustic hole 311 in a near field, the sound absorbing structure 350 may be adjusted to absorb more of the second sound emitted by the second acoustic hole 3122. In such cases, the microperforated plate 351 is inclined more toward the second acoustic hole 3122 such that the distance between the microperforated plate 351 and the second acoustic hole 3122 is less than the distance between the microperforated plate 351 and the second acoustic hole 3121. Thereby, the sound absorbing effect of the microperforated plate 351 at the second acoustic hole 3122 is greater than the sound absorbing effect of the microperforated plate 351 at the second acoustic hole 3121. In this way, the second acoustic hole 3122 disposed at the lower side LS is made to emit relatively less sound to reduce an interference cancellation between the sound emitted from the second acoustic hole 3122 and the sound emitted from the first acoustic hole 311 in the near field, thereby ensuring a listening effect at the opening of the ear canal.

FIG. 28A-FIG. 28C are schematic diagrams illustrating structures of acoustic devices according to some embodiments of the present disclosure.

In some embodiments, combining FIG. 28A-FIG. 28C, an acoustic device 1000 includes the housing 310 with a long axis direction Y and a short axis direction Z that are perpendicular to a vibration direction of the diaphragm 320 (i.e., a thickness direction X) and are orthogonal to each other, and a microperforated plate structure is disposed in the long axis direction. For example, there is an angle between a side of the microperforated plate 351 facing the second acoustic cavity 340 and the long axis direction Y, and the angle is in a range of 0°-90°. Specific instructions regarding the thickness direction X, the long axis direction Y, and the short axis direction Z may be found in FIG. 3A. It is important to know that the angle here refers to an absolute value of an angle between the side of the microperforated plate 351 and the long axis direction Y. For example, for the microperforated plate sound absorbing structures 350 and 350′ as shown in FIG. 28 C, the angle between the side of the microperforated plate facing the second acoustic cavity 340 and the long axis direction Y is 90°.

In some embodiments, there is an angle β between an arrangement direction of the microperforated plate 351 and the long axis direction Y, and 0°≤β≤90°. In some embodiments, the side of the microperforated plate 351 facing the second acoustic cavity 340 is substantially parallel to the long axis direction Y, as shown in FIG. 28A. In some embodiments, an angle β between the side of the microperforated plate 351 facing the second acoustic cavity 340 and the long axis direction Y is greater than 0° and smaller than 90° as shown in FIG. 28B. In some embodiments, as shown in FIG. 28C, the side of the microperforated plate 351 facing the second acoustic cavity 340 is substantially perpendicular to the long axis direction Y. In some embodiments, to ensure a sound absorbing effect of the microperforated plate sound absorbing structure, when the side of the microperforated plate 351 facing the second acoustic cavity 340 is substantially perpendicular to the long axis direction Y, the microperforated plate 351 is disposed facing or near the second acoustic hole, thereby minimizing the distance between the microperforated plate 351 and the second acoustic hole and enhancing the sound absorbing effect.

In some embodiments, to adapt to the wearing state of the acoustic device shown in FIG. 3A where the sound generation component extends into a concha cavity, a size of the sound generation component along the long axis direction Y is appropriately increased so that the end FE of the sound generation component is located in the concha cavity of the user. In some embodiments, when the acoustic device 1000 has a relatively great size in the long axis direction Y, to better absorb the sound waves from the second acoustic hole, the microperforated plate 351 is disposed near the second acoustic hole. In some embodiments, to avoid components inside the housing 310 (e.g., a diaphragm, a magnetic circuit component, etc.) from affecting the microperforated plate 351 in absorbing of sound waves from the second acoustic hole, the microperforated plate 351 is disposed substantially on a side of the diaphragm along the long axis direction Y. In some embodiments, when the diaphragm 320 does not completely cover the second acoustic cavity 340 along the long axis direction Y, a baffle 313 is arranged along the long axis direction Y, the baffle 313 and the diaphragm 320 separate an interior of the housing 310 to form the first acoustic cavity 330 and the second acoustic cavity 340.

In some embodiments of the present disclosure, a size of the sound generation component along the long axis direction Y is appropriately increased by setting the microperforated plate sound absorbing structure substantially on a side of the diaphragm along the long axis direction Y, so that in the wearing manner shown, for example, FIG. 3A, the end FE of the sound generation component better extends into the concha cavity. Alternatively, when the microperforated plate sound absorbing structure is disposed on a side of the diaphragm along the long axis direction Y, the cavity of the sound generation component that extends out along the long axis direction Y may have a sufficiently great space. For example, in a thickness direction, as the cavity of the sound generation component that extends out does not include the magnetic circuit assembly, parameters such as a position and a height of the cavity of the microperforated plate sound absorbing structure may not be limited by the magnetic circuit assembly. As a result, the height of the cavity of the microperforated plate sound absorbing structure may be increased to enhance the sound absorbing effect. Alternatively, when the height of the cavity of the sound absorbing structure is constant, the microperforated plate sound absorbing structure may be arranged upward (e.g., in a positive direction of the X-direction shown in FIG. 28A), thereby reducing the thickness of the sound generation component.

It should be known that the microperforated plate sound absorbing structures shown in FIGS. 28A-28C are only used as an example, and when the microperforated plate sound absorbing structure is disposed on a side of the diaphragm along the long axis direction Y, the parameters such as the position, an orientation, etc. of the microperforated plate sound absorbing structure may not be limited to the example shown in FIGS. 28A-28C. In some embodiments, when the microperforated plate sound absorbing structure is disposed in the long axis direction Y, the side of the microperforated plate facing the second acoustic cavity 340 generally faces other sidewalls of the housing 310, for example, generally faces an upper and/or lower sidewall where the second acoustic hole is located, etc., as long as the microperforated plate predominantly faces the second acoustic cavity (i.e., does not depart from a rear side of the diaphragm), which is not limited in the present disclosure.

FIGS. 29A-29C are schematic diagrams illustrating structures of acoustic devices according to some embodiments of the present disclosure.

In some embodiments, combining FIGS. 29A-29C, the acoustic device 1100 includes a housing 310 with the long axis direction Y and the short axis direction Z that are perpendicular to a vibration direction of the diaphragm 320 (i.e., the thickness direction X) and orthogonal to each other. A microperforated plate structure may be disposed in the short axis direction. For example, there is an angle between a side of the microperforated plate 351 facing the second acoustic cavity 340 and the short axis direction Z. The angle may be in a range of 0°-90°. Specific instructions on the thickness direction X, the long axis direction Y and the short axis direction Z may be found in FIG. 3A. It is to be known that, similar to the above, the angle here refers to an absolute value of an angle between the side of the microperforated plate 351 and the short axis direction Z.

In some embodiments, there is an angle γ between an arrangement direction of the microperforated plate 351 and the short axis direction Z, and 0°≤γ≤90°. In some embodiments, the side of the microperforated plate 351 facing the second acoustic cavity 340 is substantially parallel to the short axis direction Z, as shown in FIG. 29A. In some embodiments, as shown in FIG. 29B, the angle γ between the side of the microperforated plate 351 facing the second acoustic cavity 340 and the short axis direction Z is greater than 0° and less than 90°. In some embodiments, as shown in FIG. 29 C, the side of the microperforated plate 351 facing the second acoustic cavity 340 is substantially perpendicular to the short axis direction Z.

In some embodiments, to adapt to a wearing state of an acoustic device shown in FIG. 5 where a sound generation component is located in a region of an antihelix, a size of the sound generation component along the short axis direction Z is appropriately increased to allow the sound generation component (e.g., a first acoustic hole) to be closer to an ear canal. In some embodiments, when a size of the acoustic device 1100 in the short axis direction Z is relatively great, the microperforated plate 351 is disposed near a second acoustic hole to better absorb sound waves from the second acoustic hole. In some embodiments, to avoid components inside the housing 310 (e.g., a diaphragm, a magnetic circuit assembly, etc.) from affecting the microperforated plate 351 in absorbing the sound waves from the second acoustic hole, the microperforated plate 351 and the diaphragm 310 are disposed on a side of the diaphragm along the short axis direction Z substantially. In some embodiments, when the diaphragm 320 does not completely cover the second acoustic cavity 340 in the short axis direction Z, the baffle 313 arranged along the short axis direction Z is disposed, and the baffle 313 and the diaphragm 320 together separate an interior of the housing 310 to form the first acoustic cavity 330 and the second acoustic cavity 340.

In some embodiments of the present disclosure, by disposing the microperforated plate substantially on a side of the diaphragm along the short axis direction Z, the size of the sound generation component along the short axis direction Z is appropriately increased so that, in the wearing manner shown in, for example, FIG. 5, the first acoustic hole on the sound generation component is closer to the ear canal, so that the a listening effect of the user is better. Alternatively, when the microperforated plate sound absorbing structure is disposed on a side of the diaphragm along the short axis direction Z, the cavity of the sound generation component that extends out along the short axis direction Z may have a sufficiently great space. For example, in a thickness direction, as the cavity of the sound generation component extends out does not include the magnetic circuit assembly, parameters such as a position and a height of the cavity of the microperforated plate sound absorbing structure may not be limited by the magnetic circuit assembly. As a result, the height of the cavity of the microperforated plate sound absorbing structure may be increased to enhance the sound absorbing effect. Alternatively, when the height of the cavity of the sound absorbing structure is constant, the microperforated plate sound absorbing structure can be arranged upward (e.g., in a positive direction of the X-direction shown in FIG. 29A), thereby reducing the thickness of the sound generation component.

It is to be understood that the microperforated plate sound absorbing structures shown in FIGS. 29 A-29C are only for example, and when the microperforated plate sound absorbing structure is disposed on a side of the diaphragm along the short axis direction Z, the parameters such as a position, an orientation, and other parameters of the microperforated plate sound absorbing structure are not limited to examples shown in FIGS. 29A-29C. For example, as shown in FIGS. 29A-29C, the side of the microperforated plate 351 facing the second acoustic cavity 340 faces predominantly toward an upper side where the first acoustic hole 311 is located or a side where the second acoustic hole is located (e.g., an upper side or a lower side). In some embodiments, when the microperforated plate sound absorbing structure is disposed in the axial direction Z, the side of the microperforated plate facing the second acoustic cavity 340 also faces predominantly toward other sides of the housing 310, e.g., towards two ends of the housing 310 along the long axis direction Y (e.g., towards or away from the end FE), etc., as long as the microperforated plate faces predominantly towards the second acoustic cavity (i.e., does not departs from a rear side of the diaphragm), which is not limited in the present disclosure.

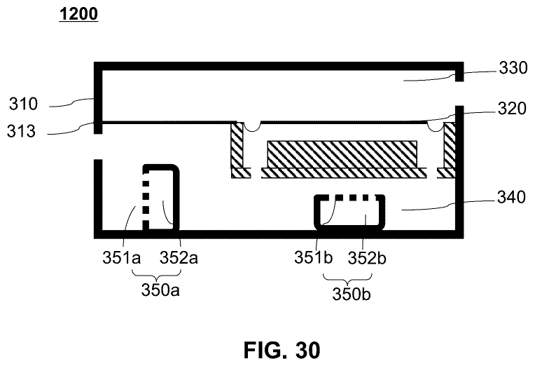

FIG. 30 is a schematic diagram illustrating a structure of an acoustic device according to some other embodiments of the present disclosure.

Combining FIG. 30, in some embodiments, a sound absorbing structure of an acoustic device 1200 includes a plurality of independently disposed sub-sound absorbing structures, for example, a sub-sound absorbing structure 350a, a sub-sound absorbing structure 350b . . . . In some embodiments, each of the sub-sound absorbing structures includes a sub-microperforated plate and a sub-cavity, e.g., the sub-sound absorbing structure 350a includes a sub-microperforated plate 351a and a sub-cavity 352a, the sub-sound absorbing structure 350b includes a sub-microperforated plate 351b and a sub-cavity 352b . . . .

In some embodiments, a plurality of smaller, independently disposed sub-sound absorbing structures are used instead of a relatively greater sound absorbing structure disposed within the second acoustic cavity 340. In some embodiments, the plurality of sub-sound absorbing structures are disposed at different positions in the second acoustic cavity 340, allowing a flexibility in designing installation positions of the sub-sound absorbing structures, thereby allowing for a full utilization of a space within the second acoustic cavity 340, which is conducive to a miniaturization of the acoustic device 1200. In some embodiments, when the acoustic device 1200 has a plurality of second acoustic holes, each second acoustic hole is correspondingly disposed with one or more sub-sound-sound absorbing structures, so that sound waves at each second acoustic hole are absorbed by the sub-sound absorbing structures to ensure a sound absorbing effect. In some embodiments, the sound absorbing effects of the one or more sub-sound absorbing structures at each second acoustic hole are differentiated by adjusting a position and a count of the sub-sound absorbing structures corresponding to each second acoustic hole. For example, to reduce a cancellation of the second acoustic hole and the first acoustic hole in a near field, the sub-sound absorbing structures are brought closer to the second acoustic hole, or more sub-sound absorbing structures are arranged around the second acoustic hole, etc. In some embodiments, parameter combinations of the plurality of sub-sound absorbing structures are different so as to make a difference in target frequency ranges of the plurality of sub-sound absorbing structures for absorbing the sound to realize the sound absorbing of different frequency bands.

The basic concepts have been described above, and it is apparent to those skilled in the art that the foregoing detailed disclosure serves only as an example and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments thereof. Such as “an embodiment,” “one embodiment,” and/or “some embodiments” means a feature, structure, or characteristic associated with at least one embodiment of the present disclosure. Accordingly, it should be emphasized and noted that “an embodiment,” “one embodiment,” or “a number of embodiments” referred to two or more times in different positions in the present disclosure do not necessarily refer to the same embodiment. In addition, certain features, structures, or characteristics in one or more embodiments of the present disclosure are suitably combined.

Additionally, unless expressly stated in the claims, the order of the processing elements and sequences, the use of numerical letters, or the use of other names as described in the present disclosure are not intended to qualify the order of the processes and methods of the present disclosure. While some embodiments of the present disclosure that are currently considered useful are discussed in the foregoing disclosure by way of various examples, it is to be understood that such details serve only illustrative purposes and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that to simplify the presentation of the present disclosure, and thereby aid in the understanding of one or more embodiments thereof, the foregoing descriptions of embodiments of the present disclosure sometimes group multiple features together in a single embodiment, accompanying drawings, or a description thereof. However, this manner of disclosure does not imply that the objects of the present disclosure require more features than those mentioned in the claims. Rather, claimed subject matter may lie in less than all features of a single foregoing disclosed embodiment.

Some embodiments use numbers to describe the number of components, attributes, and it should be understood that such numbers used in the description of the embodiments are modified by the modifiers “about,” “approximately,” or “substantially.” Unless otherwise noted, the terms “about,” “approximately,” or “substantially” indicates that a ±20% variation in the stated number is allowed. Correspondingly, in some embodiments, the numerical parameters used in the present disclosure and the claims are approximations, which change depending on the desired characteristics of individual embodiments. In some embodiments, the numerical parameters should take into account the specified number of valid digits and utilize a general digit retention method. While numerical domains and parameters used to confirm a breadth of their ranges in some embodiments of the present disclosure are approximations, in specific embodiments such values are set to be as precise as possible within a feasible range.

For each of the patents, patent applications, patent application disclosures, and other materials cited in the present disclosure, such as articles, books, specification sheets, publications, documents, etc., are hereby incorporated by reference in their entirety into the present disclosure. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those set forth herein, the descriptions, definitions and/or use of terms of the present disclosure shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. An acoustic device, comprising:
a diaphragm;
a housing configured to accommodate the diaphragm and form a first acoustic cavity and a second acoustic cavity corresponding to a front side and a rear side of the diaphragm, respectively, wherein the diaphragm radiates sound into the first acoustic cavity and the second acoustic cavity, respectively, and the sound in the first acoustic cavity and the sound in the second acoustic cavity are guided out through a first acoustic hole coupled to the first acoustic cavity and a second acoustic hole coupled to the second acoustic cavity, respectively;
a sound absorbing structure coupled to the second acoustic cavity and is configured to absorb the sound transmitted from the second acoustic cavity to the second acoustic hole in a target frequency range, wherein the sound absorbing structure includes a microperforated plate and a cavity, the microperforated plate including through holes, and the second acoustic cavity is in flow communication with the cavity through the through holes; and
a suspension structure configured to place the housing at a position near an ear canal of a user without blocking an opening of the ear canal.

2. The acoustic device of claim 1, wherein a ratio of an open area of the first acoustic hole to an open area of the second acoustic hole is in a range of 0.5-2.

3. The acoustic device of claim 1, wherein a difference of acoustic loads between the first acoustic hole and the second acoustic hole is less than 0.15.

4. The acoustic device of claim 1, wherein an angle between a normal of a side of the microperforated plate facing the second acoustic cavity and a vibration direction of the diaphragm is in a range of 0°-90°.

5. The acoustic device of claim 4, wherein the sound absorbing structure is disposed in the vibration direction of the diaphragm, and the angle between the normal of the side of the microperforated plate facing the second acoustic cavity and the vibration direction of the diaphragm is in a range of 0°-10° range.

6. The acoustic device of claim 5, further including:
a magnetic circuit assembly; and
a coil connected to the diaphragm and at least partially disposed in a magnetic gap formed by the magnetic circuit assembly, wherein after being powered, the coil drives the diaphragm to vibrate to produce sound, and the microperforated plate includes a ring structure disposed around the magnetic circuit assembly.

7. The acoustic device of claim 6, wherein a hole diameter of each through hole in the through holes is in a range of 0.2 mm-0.4 mm, a perforation rate of the microperforated plate is in a range of 1%-5%, a thickness of the microperforated plate is in a range of 0.2 mm-0.7 mm, and a height of the cavity is in a range of 4 mm-9 mm.

8. The acoustic device of claim 7, wherein the target frequency range includes 4 kHz.

9. The acoustic device of claim 6, wherein a hole diameter of each through hole in the through holes is in a range of 0.1 mm-0.3 mm, a perforation rate of the microperforated plate is in a range of 0.5%-5%, a thickness of the microperforated plate is in a range of 0.2 mm-0.6 mm, and a height of the cavity is in a range of 4 mm-10 mm.

10. The acoustic device of claim 9, wherein the target frequency range includes 2 kHz-3 kHz.

11. The acoustic device of claim 5, further including:
a magnetic circuit assembly; and
a coil connected to the diaphragm and at least partially disposed in a magnetic gap formed by the magnetic circuit assembly, wherein after being powered, the coil drives the diaphragm to vibrate to produce sound, and the microperforated plate and the magnetic circuit assembly are spaced apart in the vibration direction of the diaphragm.

12. The acoustic device of claim 11, wherein a hole diameter of each through hole in the through holes is in a range of 0.1 mm-0.2 mm, a perforation rate of the microperforated plate is in a range of 2%-5%, a thickness of the microperforated plate is in a range of 0.2 mm-0.7 mm, and a height of the cavity is in a range of 7 mm-10 mm.

13. The acoustic device of claim 12, wherein the target frequency range includes 4 kHz.

14. The acoustic device of claim 11, wherein a hole diameter of each through hole in the through holes is in a range of 0.1 mm-0.3 mm, a perforation rate of the microperforated plate is in a range of 0.5%-5%, a thickness of the microperforated plate is in a range of 0.2 mm-0.6 mm, and a height of the cavity is in a range of 4 mm-10 mm.

15. The acoustic device of claim 14, wherein the target frequency range includes 2 kHz-3 kHz.

16. The acoustic device of claim 4, wherein
the housing has a long axis direction and a short axis direction that are perpendicular to the vibration direction of the diaphragm and orthogonal to each other,
the sound absorbing structure is disposed on a side of the diaphragm along the long axis direction, and
an angle between the side of the microperforated plate facing the second acoustic cavity and the long axis direction is in a range of 0°-90°.

17. The acoustic device of claim 16, wherein the side of the microperforated plate facing the second acoustic cavity is perpendicular to the long axis direction.

18. The acoustic device of claim 4, wherein
the housing has a long axis direction and a short axis direction that are perpendicular to the vibration direction of the diaphragm and orthogonal to each other,
the acoustic sound absorbing structure is disposed on a side of the diaphragm along the short axis direction, and
an angle between the side of the microperforated plate facing the second acoustic cavity and the short axis direction is in a range of 0°-90°.

19. The acoustic device of claim 18, wherein the side of the microperforated plate facing the second acoustic cavity is perpendicular to the short axis direction.

20. The acoustic device of claim 1, wherein the sound absorbing structure includes a plurality of independently disposed sub-sound absorbing structures, each sub-sound absorbing structure including a sub-microperforated plate and a sub-cavity.
